(19) United States
(12) Patent Application Publication
(10) Pub. No.: US 2019/0130348 A1
(43) Pub. Date: May 2, 2019

(54) SYSTEM, APPARATUS AND METHOD FOR SECURE DELIVERIES OF ITEMS TO A RESIDENCE WITH CONTROL OF DELIVERY AUTHORIZATIONS AND STORAGE TEMPERATURES, AND COMMUNICATIONS WITH DELIVERY SERVICES

(71) Applicant: SDSC, LLC, Austin, TX (US)

(72) Inventors: Marianne Mellado, Austin, TX (US); Chris Owens, Austin, TX (US); Kit Morris, Austin, TX (US)

(73) Assignee: SDSC, LLC

(21) Appl. No.: 16/171,708

(22) Filed: Oct. 26, 2018

Related U.S. Application Data
(60) Provisional application No. 62/579,246, filed on Oct. 31, 2017.
(60) Provisional application No. 62/741,817, filed on Oct. 5, 2018.

(51) Int. Cl. G06Q 10/08; G05D 23/19; G07C 9/00; A47G 29/14; A47G 29/20

(52) U.S. Cl. CPC G06Q 10/0832; G05D 23/19; G07C 9/00896; A47G 2029/147; A47G 29/20; G07C 2009/0092; A47G 29/141

(57) ABSTRACT

A container appliance for secure receiving and storing of delivered items at a residence of a final recipient may include a storage compartment, securing mechanism, thermal conditioning system and appliance management module configured to control the securing mechanism to provide authorized delivery events and to control the thermal conditioning system to establish a temperature in a thermal conditioned region.

### CROSS-REFERENCE TO RELATED APPLICATIONS

This application claims priority to U.S. Provisional Application No. 62/579,246, filed Oct. 31, 2017, and hereby claims benefit of the filing dates thereof pursuant to 37 CFR § 1.78(a)(4). The subject matter of the U.S. Provisional Application, in its entirety, is expressly incorporated herein by reference.

This application claims priority to U.S. Provisional Application No. 62/741,817, filed Oct. 5, 2018, and hereby claims benefit of the filing dates thereof pursuant to 37 CFR § 1.78(a)(4). The subject matter of the U.S. Provisional Application, in its entirety, is expressly incorporated herein by reference.

### FIELD OF THE INVENTION

The disclosure relates to systems, apparatus and methods for delivery of parcels, packages, and goods.

### BACKGROUND OF THE INVENTION

Package delivery services, express delivery services, and postal services (collectively, “package delivery service” or “delivery service”) for shipping parcels and packages from businesses to final recipients in different cities, states and countries are provided, for example, by United Parcel Service (UPS), Federal Express (FedEx), and the United States Postal Service (USPS). As used herein, “parcel” refers generally to a package to be routed to the recipient by a package delivery service. Parcels may bear the name and address of the recipient. Parcels may range in size, for example, from a standard mail package to a box large enough to contain and protect what is sent in it, up to a size that can be transported in a wheelbarrow or on a hand truck, as may be limited by rules of the delivery service or by the capabilities of parcel handling equipment utilized by the delivery service. Parcels may bear a shipping label used for the delivery service, such as a FedEx shipping label. Parcels may bear an identifier, such as a barcode and/or radio frequency identification (RF or RFID) tag, so they can be tracked at all the stages of shipping until received by the final recipient.

Package delivery services may include package routing, handling and sorting equipment infrastructure located in large distribution facilities in major cities and hubs locations; a fleet of interstate and international shipping vehicles such as cargo trucks and cargo planes; a fleet of residential delivery vehicles and couriers; a population of public, self-service shipping stands for taking possession of parcels from businesses which may place parcels into a secure container at the stand; and information technology infrastructure supporting operations. The information technology system may include routing algorithms for efficiently routing shipments of groups of parcels between hubs and cities, and for routing the final delivery vehicles and couriers carrying parcels to the residences or offices (hereinafter, residences and offices being referenced, collectively, as “residences”) of each final recipient. The information technology system may include wireless, hand-held smart barcode readers for scanning packages when making deliveries to the final recipients. The hand-held smart barcode readers may include a touchscreen or other input device for the delivery person to obtain the signature of the final recipient or other individual at the residence.

Local businesses such as flower shops, pizza joints, neighborhood grocery stores, and pharmacies operate innumerable specialized local delivery services. Such local delivery services make local deliveries to the residences of final recipients of deliveries including, for example, packages, bagged or boxed grouped items such as packaged and unpackaged goods, and individual items or grouped items such as prepared and unprepared foods. Where local customers request that goods be delivered to final recipients in other locales, the local businesses may utilize a national or regional delivery service of the type described herein above. As used herein, “item”, “items”, “delivery items”, “delivery” or “deliveries” for example, and without limitation, may include and refer to packages, parcels, goods, items, items in containers, uncontained items, and grouped items in common containers such as bags or boxes. As used herein, the words “delivery” or “deliveries” also may refer, without limitation, to delivery events or physical acts of delivery, where context dictates these meanings.

Delivery services may be unavailable, unsuitable, unreliable, or inefficient for shipping and making deliveries of some items from businesses to final recipients. Local delivery services may be inefficient, such as when a final recipient is not available to receive the delivery, the business making local deliveries is understaffed, traffic delays are encountered, or numerous orders exceeding the usual delivery capacity of the business are received and must be delivered in a short period. For reasons stated above and for other reasons that will become apparent to those skilled in the art upon reading and understanding the present specification, there is a need for improved systems, apparatus and methods for secure deliveries.

### BRIEF DESCRIPTION OF THE INVENTION

The above-mentioned shortcomings, disadvantages and problems are addressed herein, as will be understood by those skilled in the art upon reading and studying the following specification.

As used herein, “residence” shall mean a residence, residential location, dwelling, home, business, business location, office, office location, real property, real estate parcel, physical delivery location for a final recipient, real property under rightful control of a final recipient, real property rightfully used by a final recipient for receiving shipments or deliveries, or a structure under control or used by a final recipient.

In one aspect, embodiments may include systems, apparatus, and methods for making secure deliveries of items to residences of final recipients, with control of delivery authorizations and storage temperatures, and communications with delivery services.

In one aspect, embodiments of disclosed subject matter may include systems, apparatus and methods for secure deliveries from businesses to a final recipient of a plurality of disparate parcels, packages, and grouped items received from different delivery entities at different times at the residence of the final recipient.

In one aspect, embodiments may provide secure deliveries from businesses to a final recipient of a plurality of disparate parcels, packages, and grouped items at the residence of the final recipient at any time, without requiring or scheduling the presence or active participation of the recipient or a trusted individual at each residence, and also without incurring delays for the delivery agent to wait and engage in personal interactions with the final recipients or trusted individuals at each residence. Embodiments may provide secure deliveries to the residence of a final recipient as herein disclosed, without requiring or scheduling the presence or active participation of the recipient or a trusted individual at the residence, and without granting access for a delivery person to enter inside the residence. In an aspect, deliveries received at the residence of the final recipient may include both perishable and non-perishable items, and items requiring a predictable temperature controlled environment or limited exposure to sunlight. Such items may include, for example, prepared foods, fresh foodstuffs, and medications. In one aspect, deliveries of such items may be secured to prevent ruin by scavenging animals such as dogs or rodents attracted by smell. In an aspect, deliveries received at the residence of the final recipient may include high value items and may be secured to prevent theft.

In one aspect, embodiments may provide secure deliveries from businesses to final recipients of a plurality of disparate parcels, packages, and grouped items, including both perishable items and non-perishable items, at the residences of the final recipients. In an aspect, embodiments may provide secure, temperature-controlled deliveries at the residence of a final recipient at any time, or during authorized time windows established by the final recipient or established by agreement of the final recipient and a delivery service, or when authorized by communications with the delivery agent of a delivery service. In an aspect, embodiments may provide secure, temperature-controlled deliveries at the residence of a final recipient without requiring or scheduling the presence or active participation of the recipient or a trusted individual at the residence. In an aspect, embodiments may provide secure deliveries at the residence of a final recipient without the delivery agent for the delivery service incurring a delay to wait for the intended final recipient to appear at the residence, or to engage in personal interactions with the final recipient or another trusted individual at the residence.

In one aspect, embodiments may provide secure deliveries including direct or indirect communications, either in advance or in real-time, between the final recipient and a delivery service mode or point of contact, such as a route delivery person or delivery agent, a wireless device of a residential delivery person, or automated delivery drone of a delivery service. As used herein, “delivery agent” may include, without limitation, a delivery person or automated delivery drone, of a delivery service. In an aspect, embodiments may provide secure deliveries, with communications of delivery terms and conditions to the delivery agent or other mode of contact for the delivery service, from the final recipient. Embodiments may include communication of instructions from the residential delivery customer, or from a final recipient's container appliance or system. Embodiments may include communication of instructions from a business sending the delivery to the residence of the final recipient. In an aspect, embodiments may provide secure deliveries at the residence of a final recipient including communications of delivery conditions or instructions for maintaining a parcel or delivery item in desired or essential temperature-controlled condition, other controlled environment conditions, secured condition, or other specified limits or restrictions placed on the delivery agent, such as a delivery person or delivery drone, when making delivery at the residence.

In one aspect, embodiments may provide secure deliveries from businesses to final recipients of a plurality of disparate parcels, packages, and grouped items, including both perishable items and non-perishable items, at the residences of the final recipients at any time, without requiring or scheduling the presence or active participation of the recipient or a trusted individual at each residence, and also without the delivery agent incurring delays to wait and engage in personal interactions with the recipient at each residence. In an aspect, embodiments may provide secure deliveries at the residence of a final recipient under secure, temperature-controlled conditions and at designated delivery times specified by the final recipient.

Embodiments, including apparatus, systems and methods, of varying scope are described herein. In addition to the aspects and advantages described in this summary, further aspects and advantages will be understood by reference to the following drawings, detailed description and claims.

### BRIEF DESCRIPTION OF THE DRAWINGS

FIG. 1 is a simplified block diagram illustrating a system for secure deliveries 100 in an exemplary embodiment.

FIG. 2 is a simplified block diagram illustrating a container apparatus 200 as shown generally in FIG. 1, in an exemplary embodiment.

FIG. 3 is a flowchart illustrating aspects of a method 300 for secure deliveries in an exemplary embodiment.

FIG. 4 is a simplified front perspective view illustrating a container appliance 400 in an exemplary embodiment.

FIG. 5 is a simplified enlarged partial front perspective view with schematic elements, illustrating aspects of container appliance 400 as shown generally in FIG. 4.

FIG. 6 is an end perspective view of a container system 600 in an exemplary embodiment, installed for use at a residence.

FIG. 7 is a front perspective view of the container system 600 shown generally in FIG. 6.

FIG. 8 is an exploded perspective view similar to FIG. 7, showing the container appliance and ornamental panels of container system 600.

FIG. 9 is a perspective isolation view similar to FIG. 8, showing the container appliance of system 600.

FIG. 10 is a perspective isolation view similar to FIG. 9, showing the container appliance of a container system 700 in an exemplary embodiment.

FIG. 11 is an exploded perspective view similar to FIG. 8, illustrating container system 700, the container appliance of same being shown generally in FIG. 10.

FIG. 12 is a front perspective view similar to FIG. 7, illustrating container system 700 as shown generally in FIG. 11.

FIG. 13 is a schematic simplified cross-sectional view of the container appliance of container system 600, taken generally along 13-13 in FIG. 9.

FIG. 14 is a simplified first screenshot view illustrating an exemplary first user interface for the container system 600 shown generally in FIG. 6 depicting an order delivery schedule message.

FIG. 15 is a simplified second screenshot view similar to FIG. 14, illustrating an exemplary second user interface for the container system 600 depicting a container opening code authorization message.

FIG. 16 is a simplified second screenshot view similar to FIG. 14, illustrating an exemplary third user interface for the container system 600 depicting an order delivery message.

FIG. 17 is a simplified second screenshot view similar to FIG. 16, illustrating the exemplary third user interface for the container system 600 depicting a container opened message.

FIG. 18 is a simplified partial front view of a multi-purpose input interface of a combined control subsystem and communications subsystem of the container system 600 shown generally in FIG. 9, with an indicator light illuminated to show unlocked status.

FIG. 19 is a simplified schematic logistic flowchart illustrating aspects of the container system 600 shown generally in FIG. 9.

FIGS. 20-25 illustrate an exemplary series of operations of container system 600 for a delivery by a national delivery service, from generation of a planned order delivery message through automatic re-locking of the container system after the national delivery service order is physically received in the container system.

FIGS. 26-31 illustrate an exemplary series of operations of container system 600 for a delivery by a local business, from generation of a delivery code authorization message through automatic re-locking of the container system after the local business delivery is physically received in the container system.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments and disclosure. It is to be understood that other embodiments may be utilized, and that logical, mechanical, electrical, and other changes may be made without departing from the scope of the embodiments and disclosure. In view of the foregoing, the following detailed description is not to be taken as limiting the scope of the embodiments or disclosure.

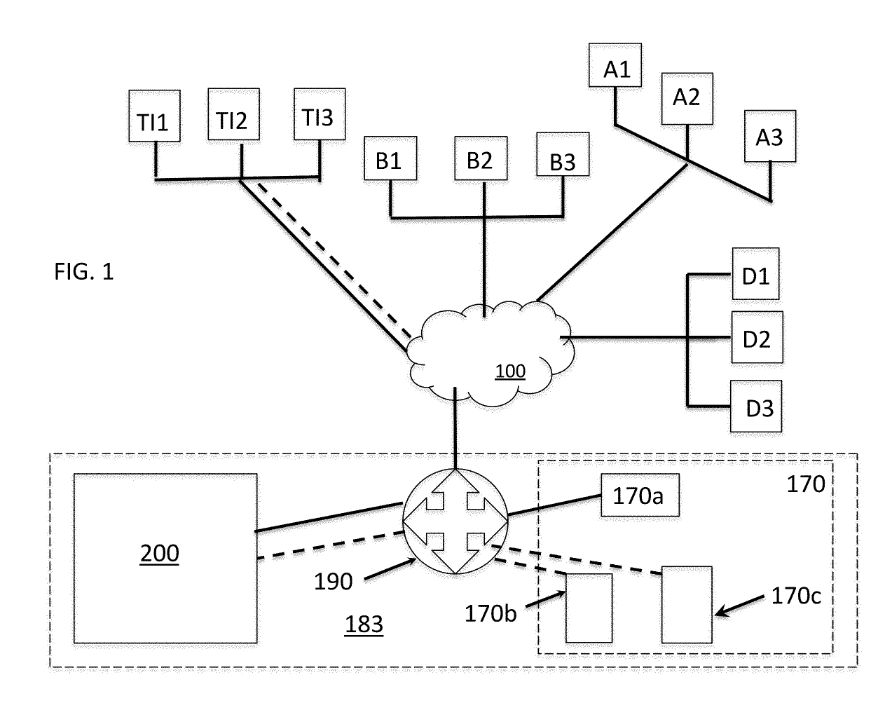

FIG. 1 is a simplified block diagram illustrating a system 100 for secure deliveries in an exemplary embodiment. System 100 may include a container appliance 200 as described in further detail elsewhere herein. System 100 may include a communications network 110 such as, for example, the Internet and cooperating wireless or wired communications network infrastructure configured and operable to enable communications. Communications network 110 may include a plurality of wired or wireless communication links 120 configured to transmit or carry communications according to suitable communication protocols.

System 100 may include a plurality of wireless devices 130 each associated with a delivery agent of a shipping service. Such delivery agents may include, for example, delivery vehicle operators, delivery personnel, delivery drones, and delivery vehicles of the delivery services, who deliver items to the residences of final recipients. Delivery agents may include, for example, delivery personnel, delivery vehicles and delivery drones of delivery services such as UPS, FedEx, or in-house delivery services operated by local businesses.

System 100 may include a plurality of delivery agent servers 140 each associated with a delivery service provider. Each of the delivery agent servers 140 may be configured to provide delivery information to the delivery agents and to provide delivery communications, such as estimated delivery times and listings of the delivery items, to the container appliance 200 or computing devices 170 of a final recipient.

System 100 may include a plurality of business shipper servers 150 of the different businesses shipping or sending items to final recipients via different delivery services. Each of the business shipper servers 150 may be configured to provide item-specific and shipment-specific communications to the container appliance 200 or computing devices 170 of a final recipient, such as a listing of delivery items shipped to a final recipient via a delivery service, the identity of the particular delivery service, shipping date, and the shipment tracking number provided to the business shipper by the delivery service.

System 100 may include the final recipient's computing devices 170. The computing devices 170 may include any suitable computing device such as, without limitation, laptops, desktops, servers, smartphones, wireless tablet computers, smart devices, and IoT devices. System 100 may include a local network 180 at the residence location 185 of each final recipient, and each local network 180 may include a local network router 190 configured for routing communications among devices and over a suitable connection to external communications network 110.

System 100 also may include unique tracking indicia 160 affixed to each delivery item, or packaging thereof, for tracking location and identification of each delivery item. The unique tracking indicia 160 may be configured to record and communicate tracking information for the delivery item. Where a delivery item is identified as requiring a controlled temperature condition, such as refrigerated condition, frozen condition or heated condition, the unique tracking indicia 160 may include a temperature sensor for the delivery item. The tracking indicia 160 may include a communications interface or mode such as, for example, an active or passive communication mode such as Radio Frequency (RF) mode to provide information when queried by an RF mode active detector, or any other suitable passive or active signal transmission mode, including without limitation, one or mode barcodes or other scannable identifiers that may be provided on shipment packaging. Where a delivery item is identified as being perishable and requiring delivery by a specified expiration date, or time of day, the unique tracking indicia 160 may include a delivery deadline or expiration deadline for completing delivery of the delivery item. It will be understood that unique tracking indicia 160 may include RF tags, RFID tags, barcodes and other indicia that can provide tracking information when queried or issued an instruction. Unique tracking indicia 160 may include memory for storing tracking information such as, for example, storing a record of temperature sensor data for auditing temperature conditions and temperature history of temperature controlled items during shipment and delivery.

Referring to FIG. 1, system 100 may include a container appliance 200 located at the residence of a final recipient. Container appliance 200 may be configured to determine authorized delivery events for a delivery service to effectuate deliveries of items to secure, temperature-controlled storage compartments. Container appliance 200 may be configured to determine authorized removal events for enabling a final recipient or trusted individual at the residence to remove delivery items stored in the storage compartments. Container appliance 200 may be configured to determine and effectuate secured storage periods of delivered items with controlled temperature conditions maintained in the secure, temperature-controlled storage compartments, from each authorized delivery event to a corresponding authorized removal event. Container appliance 200 may be configured for communications with delivery agents or other communications modes of the delivery services, and with the final recipient.

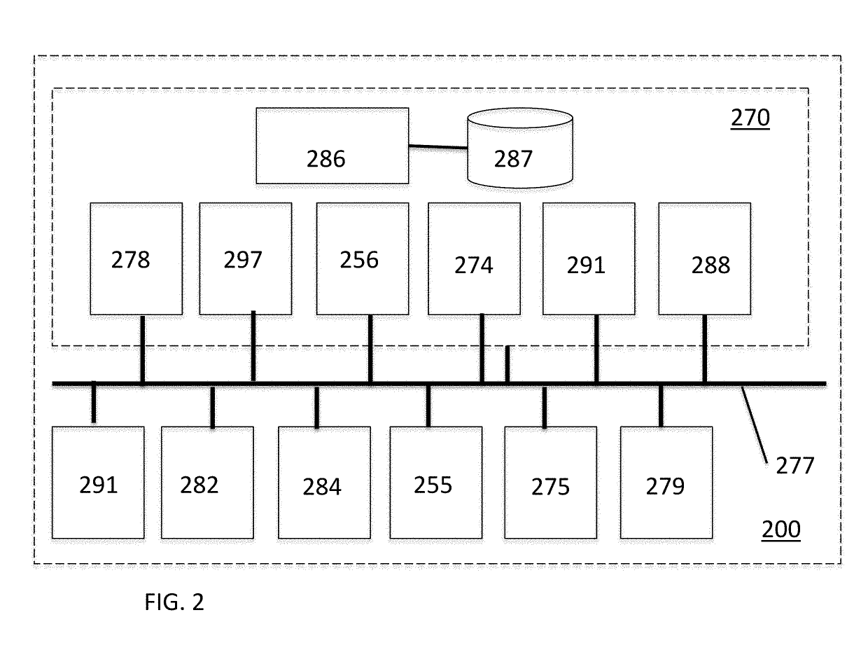

FIG. 2 is a simplified block diagram illustrating a container appliance 200, as shown generally in FIG. 1, in an exemplary embodiment. Container appliance 200 is configured and operable for secure receiving and storing of delivered items (not shown in FIG. 2) at a residence of a final recipient. The delivered items each may include unique tracking indicia 160 (shown in FIG. 1) configured and operable to be accessed, scanned or queried, or operable to broadcast, tracking information about the delivery item.

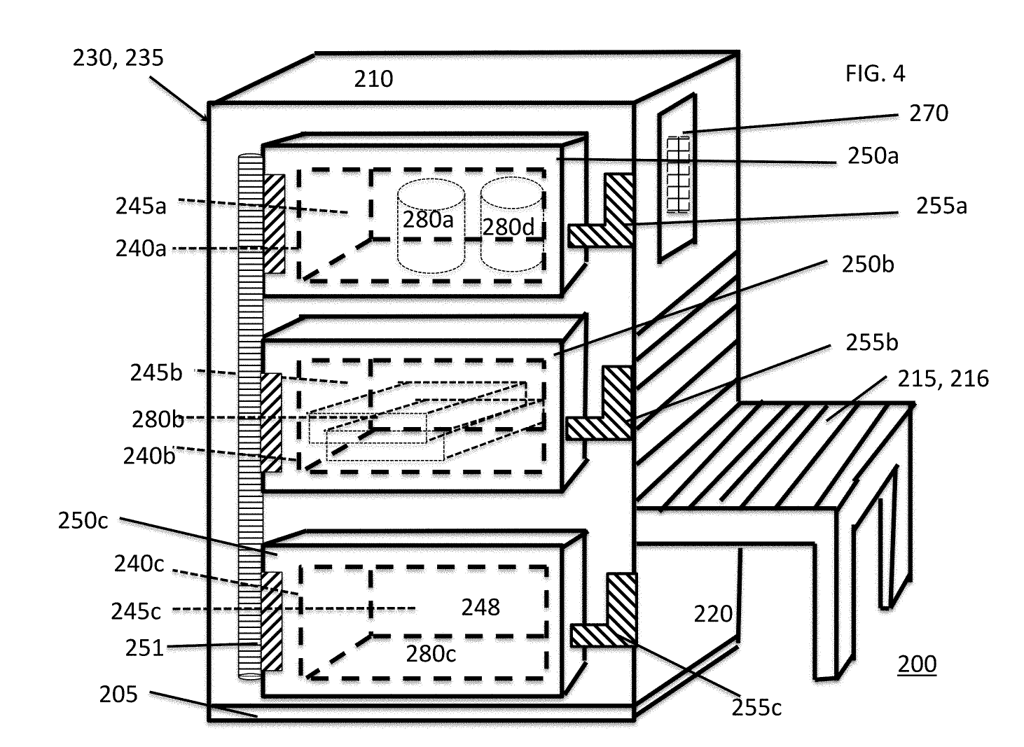

FIG. 4 is a simplified front perspective view illustrating a container appliance 200 in an exemplary embodiment. Container appliance 200 may include a structural frame 205 and an exterior 210 mounted on the structural frame 205. In the particular embodiment shown in FIG. 4, the container appliance 200 may have an integrated structure such as, for example, an integrated assembly of insulated panels mounted on the structural frame 210 and thus forming the exterior 210. It will be understood that container appliance 200, including the structural frame 205 and insulated panels forming the exterior 201, and a thermal conditioning system and appliance management system thereof, may be manufactured, arranged and assembled in the same way and manner of a residential or commercial refrigerator or freezer. In an embodiment, a container appliance may have a major structure manufactured of assembled insulated panel construction supported on an appliance frame, in the manner and construction of an electric, insulated wine bottle chilled storage appliance such as the GE Wine Center cooler, or GE Profile refrigerators (GE Appliances, a Haier Company, Louisville, Ky.).

In an embodiment, a container appliance may have a major structure of an integral or unitary molded plastic and insulating foam cooler structure, manufactured in the same or similar manner of a molded plastic and foam recreational ice-containing cooler of the type available from Igloo Products Corp. (Katy, Tex.) or Yeti Inc. (Austin, Tex.). In an embodiment, a container appliance may have an integrated or unitary molded or stamped construction of primarily metal with internal insulating foam, manufactured in the same or similar manner of a metal and foam recreational or commercial ice-containing cooler of the type available from Igloo Products Corp. (Katy, Tex.) or The Coleman Company Inc. (Wichita, Kans.). It will be understood that the major structure may be manufactured in any manner that provides essential structure and functions.

Returning to FIG. 4, visible portions of exterior 210 may have ornamental appearance elements 215 complementing the appearance of exterior decor at the residence. Ornamental appearance elements 215 may include changeable elements such as, for example, a plurality of interchangeable exterior panels 220 secured to the appliance frame 205 or exterior 210 by suitable threaded fastener combinations, such as bolt and nut combinations (not shown). The changeable elements and ornamental appearance elements 215 may be selected and installed for aesthetic consistency and security. Ornamental appearance elements 215, for example, may be selected to camoflauge or conceal the appearance of container appliance 200 to casual observers passing a residence in a vehicle or on foot. Ornamental appearance elements 215 also may perform other functions. These functions may include the function of seating, such as bench seating 216. Ornamental appearance elements 215 also may function as a table surface (not shown).

In the embodiment shown in FIG. 4, container appliance 200 includes a set of exterior walls 230. Cooperation of the set of exterior walls 230 defines a major structure 235. The major structure 235 includes the set of exterior walls, including specifically a rear wall, a pair of side walls, a bottom wall, and a top wall joined in fixed, integral relationship and supported by appliance frame 205. The major structure 235 includes a plurality of door portals 240a, 240b, 240c each providing access to a respective storage compartment 245a, 245b, 245c defined in an interior 248. Container appliance 200 includes a plurality of doors 250a, 250b, 250c each supported for pivoting movement on a set of hinges 251 relative to a mating portion of the major structure 235 for mating sealed engagement therewith. Container appliance 200 may include seals for each door and door portal (not shown). Each of the storage compartments 245a, 245b, 245c is accessible from outside said container appliance 200 by a delivery agent during an authorized delivery event, for said each storage compartment 245a, 245b, 245c to receive a respective delivered item or grouped items from the delivery agent.

Container appliance 200 may include a securing mechanism 255 (shown in FIG. 2) which is automated and selectively controllable to enable access, deny access, and prevent access to the storage compartments 245a, 245b, 245c from outside the container appliance 200 through the door portals 240a, 240b, 240c. In the configuration shown in FIG. 4, securing mechanism 255 includes a set of door securing mechanisms 255a, 255b, 255c each corresponding to a respective door 250a, 250b, 250c. The door securing mechanisms 255a, 255b, 255c interact with the respective doors 250a, 250b, 250c to prevent each door from opening when selectively controlled to deny access, where access is not authorized, such as when a delivery event or removal event is not authorized. The door securing mechanisms 255a, 255b, 255c also interact with the respective doors 250a, 250b, 250c to prevent each door from opening when selectively controlled to secure the storage compartments 245a, 245b, 245c against access during each secured storage period, and thus prevent unauthorized removal of items from the storage compartments 245a, 245b, 245c during each secured storage period. The door securing mechanisms 255a, 255b, 255c interact with the respective doors 250a, 250b, 250c to enable opening of each door when selectively controlled to enable access where access is authorized, such as during authorized delivery events and authorized removal events.

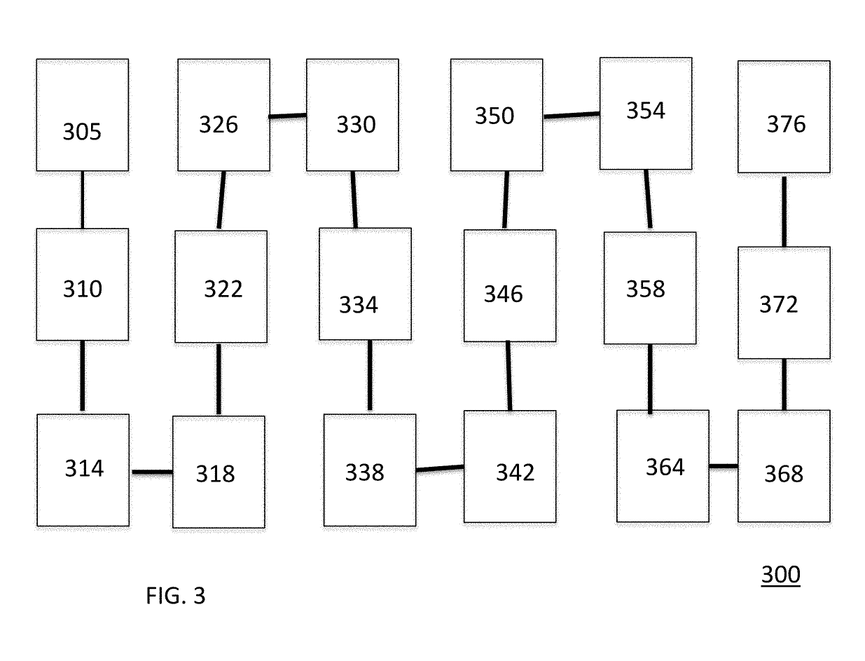

Referring to FIG. 3, container appliance 200 may include an appliance management module 270 configured and operable to control operations of the appliance container 200. In the illustrated embodiment, appliance management module 270 is configured to control operation of securing mechanism 255, including the set of door securing mechanisms 255a, 255b, 255c as described hereinabove. In the illustrated embodiment, appliance management module 270 is configured to control operation of a thermal conditioning system 275 to establish and maintain temperatures of thermal controlled regions 280a, 280b, 280c in the respective storage compartments 245a, 245b, 245c during each secured storage period, to provide essential or designated temperatures for delivered items stored therein. Appliance management module 270 may include communications management module 291 (shown in FIG. 2) configured to control operation of a local communication system 282 operable for local communications at the residence 185 with delivery agents, the final recipient and trusted individuals at the residence. Referring to FIG. 2, communications management module 291 of appliance management module 270 is configured to control operation of a network communication system 284 operable to provide communications with remote devices over the communications network 110. Appliance management module 270 may include a premises management module 297 configured to control, and to receive information from, a local premises monitoring system 291 operable for sensing or detecting the presence of delivery agents at the residence. Appliance management module 270 is configured to control local communication system 282 for issuing communications requesting, and for receiving, qualifying identification information from delivery agents at the residence. Communications may be received from any suitable input device or sensor including, for example, microphone, scanner, touchscreen, camera, or other suitable input interfaces or sensors. Communications may be issued from any suitable output device including, for example, speakers, visual displays, alarms and notification lights such as LEDs. Local communication system 282 may issue local notifications to the final recipient or trusted individuals at the residence, or to delivery agents at the residence.

Referring to FIG. 2, appliance management module 270 may include security management module 256 configured to determine and control operating periods for the securing mechanism 255, including the set of door securing mechanisms 255a, 255b, 255c (shown in FIG. 4). The operating periods may include, for example, authorized delivery events, authorized removal events, and secured storage periods.

Referring to FIG. 4, appliance management module 270 is configured to determine and control operating periods for the thermal conditioning system 275. Thermal-conditioning operating periods may include, for example, cooling periods, heating periods, temperature maintaining periods, temperature adjustment periods and unconditioned periods for thermal conditioned regions of storage compartments, or items stored therein. It will be understood that thermal conditioning system 275 may be controlled to establish and maintain temperatures in thermal conditioned regions that are immediate to a plurality of different delivered items. So, for example, in an embodiment, thermal conditioning system 275 may be controlled to establish and maintain, during a secured storage period, a chilled condition in a first thermal controlled region 280a of a first storage compartment 245a and in a second thermal controlled region 280d of first storage compartment 245a; a heated condition in a thermal controlled region 280b of a second storage compartment 245b; and a frozen condition in a thermally controlled region 280c or a third storage compartment 245c. Thermal conditioning system 275 thus may be operable for establishing a temperature of at least one of a storage compartment, a thermal conditioned region of a storage compartment, and a delivered item stored in a storage compartment, during a temperature-controlled, secured storage period.

As shown in FIG. 2, appliance management module 270 includes a processor 286 and memory 287 combination operable to execute instructions to perform all functions of the module, including controlling all systems of the appliance container 200. Appliance management module 270 may include a system bus 277. Appliance management module 270 may include a power management module 278 for managing a power supply system 279. It will be understood that power supply system 279 may be configured for connection to residential power system, such as via a wall socket connection of a standard 110 volt AC residential system, or other suitable power supply, and may include a battery backup power supply. Power supply system 279 also may include a solar or other suitable power source. The appliance management module 270 may include a thermal management module 289 configured to control the thermal conditioning system 275. The thermal management module 289 may control the thermal conditioning system 275 to establish a designated temperature condition for each delivered item in thermal conditioned zones of the storage compartments during each secured storage period. The appliance management module 270 may include an access management module 290 configured to control the securing mechanism 250. The access management module 290 may control the securing mechanism 250 to permit access to the storage compartments during authorized delivery events and authorized removal events; deny access where access by the delivery agent or individual at the residence is not authorized; and prevent access during each secured storage period. The appliance management module 270 may include a communications management module 291 configured to control the local communication system 282 and to control a network communications system 284 and network interface 288. Communications management module 291 may control the local communication system 282 to receive and issue local communications with delivery agents, final recipients and trusted individuals at the residence. Communications management module 291 may control the network communications system 284 in sending and receiving communications via the network interface 288 over communications network 110 to computing devices 170 of the final recipient, business shipper servers 150, delivery service servers 140, delivery agent wireless devices 130, and IoT devices 160 affixed to or carried in packages during shipment and delivery. For example, the communications management module 291 may control either or both of the local communication system 282 and the network communications system 284, to send and receive communications to a wireless device 160 of a delivery agent, informing the delivery agent that an authorized delivery event and time window have been established, with instructions for receiving different delivery items in different storage compartments under different temperature-controlled conditions. The communications management module 291 may control the network communications system 284 to receive communications from the delivery agent over the local communications system 282, or from a wireless device 160 of a delivery agent over the network communications system 284, requesting access to a storage compartment during the period of an authorized delivery event, for placing delivered items therein. For example, the communications management module 291 may control either or both of the local communication system 282 to send and receive local communications with the final recipient or a trusted individual at the residence, and may control the network communications system 284, to send and receive communications over the communications network 110 to a computing device 170 of the final recipient or a trusted individual, informing them that an authorized delivery event and time window have been established, that delivery items have been received in different storage compartments under different temperature-controlled conditions, and informing them that the received items will be maintained in temperature-controlled, secure condition in the storage compartment for a determined secured storage period. The communications management module 291 also may control either or both of the local communication system 282 to send and receive local communications with the final recipient or a trusted individual at the residence, and may control the network communications system 284, to send and receive communications over the communications network 110 to a computing device 170 of the final recipient or a trusted individual, informing them that an authorized removal event and time window have been established, and instructing them to remove delivery items from the storage compartments.

In an embodiment, appliance management module 270 may include thermal management module 274 configured to control the thermal conditioning system 275. Thermal management module 274 may be configured to control the thermal conditioning system 275 to establish a designated temperature by reference to a delivery time for the delivered item. Appliance management module 270 may determine delivery time by reference to an accessible record of a planned delivery schedule for the delivery agent or delivery service. Appliance management module 270 may determine delivery time by reference to a near real-time, or real-time, communication with the delivery agent or delivery agent to obtain location information or routing information for the delivery agent while the delivery route is in progress.

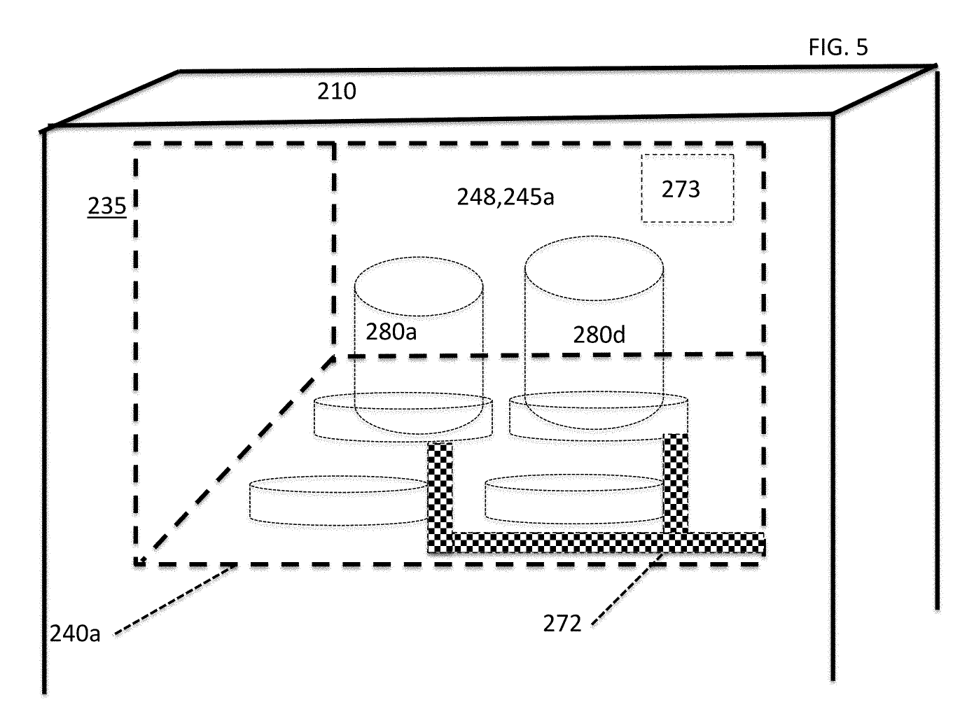

In an embodiment, appliance management module 270 may determine or select among a plurality of thermal controlled regions 280a, 280b, 280c, 280d in the storage compartments 245a, 245b, 245c for receiving and storing delivery items to minimize power consumption. As best shown in FIG. 5, the appliance management system 270 (FIG. 2) may identify that a thermal conditioned region 280a, 280d may be smaller relative to a larger region in the interior 248, such as a larger storage compartment 245a or larger region of a storage compartment 245a. In an embodiment, for example, appliance management module 270 (FIG. 2) may determine or select among a plurality of thermal controlled regions 280a, 280b, 280c, 280d (FIG. 4) in the same or different storage compartments 245a, 245b, 245c (FIG. 4) for receiving and storing a plurality of delivery items at the same or different temperatures. The thermal conditioning system 270 may include, for example, a direct thermal transfer portion 272 including pressurized thermal conditioning fluid in a liquid state, forced through passages in communication with direct thermal conditioning paths, such as metal seats (FIG. 5), The thermal conditioning system 270 may include, for example, an indirect thermal transfer portion 273 such as forced air or a thermal transfer fluid in gas or liquid state, at a selected temperature determined by the appliance management module 270, forced through passages and through selectively controllable portals to provide designated temperatures in minimized thermal conditioned regions for delivery items with minimal power consumption. Referring to FIG. 5, it will be appreciated that such fluid control may be provided in combination with establishing direct thermal transfer pathways 272 to store delivered items at different temperatures in a storage compartment 245a that is not maintained at a constant, quiescent temperature throughout the compartment 245a. Referring to FIG. 5, for example, the appliance management module 270 may control the thermal conditioning module 275 to maintain and store a first delivery item such as a half gallon of ice cream in a first thermal conditioned region of a shared, common chilled storage compartment, adjacent to a second delivery item such as a gallon of chilled milk, which is not frozen but rather is maintained at a temperature above freezing in a second thermal conditioned region. So, for example, the ice cream container may be placed in the storage compartment in direct physical contact with a very low temperature metal seat, to establish the first thermal conditioned region 280a of the storage compartment where the carton of ice cream is maintained in frozen condition; and, the gallon of chilled milk may be placed in direct physical contact with a smaller, less cold metal seat and in thermal communication with chilled air dissipated from the first thermal conditioned zone having the carton of frozen ice cream, such that adjacent chilled milk in the second thermal conditioned region 280b is maintained at the designated cold temperature above freezing. Further, one or more portals providing chilled air into the compartment for indirect thermal transfer pathway 273.

In an embodiment, the appliance management module 270 may be configured to control thermal conditioning system 275 to establish a designated temperature in relation to delivery time information for an authorized delivery event. In an embodiment, the appliance management module 270 may be configured to control the thermal conditioning system 275 to establish the designated temperature in relation to temperature information for the delivered item during a secured storage period. In an embodiment, the appliance management module 270 may be configured to control thermal conditioning system 275 to establish a designated temperature in relation to near-real time temperature information for the delivered item during a secured storage period. In an embodiment, the appliance management module 270 may be configured to control thermal conditioning system 275 to control the thermal conditioning system to establish the designated temperature in relation to near-real time temperature information for the delivered item during the authorized delivery event or during a delivery route period, wherein the delivery route period precedes the authorized delivery event.

In an embodiment, as shown in FIG. 5, a storage compartment may include a thermally conditioned region for receiving the delivered item, and the thermally conditioned region may have a selectable size property. The selectable size may include at least one selectable dimension. So, for example, a moveable insulated wall or partition (not shown) may be selectably moveable to provide the thermal conditioned region with dimensions necessary to receive the delivered item. In an embodiment, a storage compartment may include a thermally conditioned region for receiving the delivered item, where the thermal conditioned region has a selectable size property by being sub-dividable to partition the thermally conditioned region into a first, minor thermal conditioned region and a different second region which is unconditioned or controlled to establish a different thermal condition such as a different temperature in the second region, for a particular secured storage period. In an embodiment, a storage compartment may include a thermal conditioned region having a selectable size property, including a plurality of partitioned compartments each comprising a different designated thermal zone.

In an embodiment, thermal conditioning system 275 may include a refrigeration system, heating system, a combination refrigeration and heating system, or a hybrid thermal conditioning system. In an embodiment, thermal conditioning system 275 may be controllable for intermittent operation to reduce power consumption and wear on the system. In an embodiment, for example, thermal conditioning system 275 may include both a controllable direct acting thermal transfer mode and a controllable indirect thermal transfer mode for controlling temperature of one or more delivery items. The direct acting thermal transfer mode may include, for example, a metal seat in direct contact and direct thermal communication with a delivery item and in thermal communication with a thermal transfer liquid that is heated or chilled to provide both a thermal gradient and thermal pathway with high thermal capacity for directly and rapidly influencing temperature of the delivery item. The indirect thermal transfer mode may include, for example, chilled or heated air forced in proximity to the delivery item, to provide both a thermal gradient and thermal pathway with less thermal capacity for indirectly and less rapidly influencing temperature of the delivery item. The different thermal modes and pathways thus provide different thermal conditioned regions. In an embodiment, thermal conditioning system 275 may include a condensate control system configured to direct condensate produced from operation of said thermal conditioning system 275 to a condensate collector, which may be configured to prevent appearance of condensate on visible ornamental elements of said container appliance.

In an embodiment, container appliance 200 may include a premises management module 297 configured to provide delivery instructions to a delivery agent at the residence. The premises management module 297 may be configured to provide delivery instructions to a delivery agent at the residence, and the premises management module 297 may include a premises monitoring system 291 configured to detect the presence and receive qualifying identification information for a delivery agent. The premises management module 297 may be configured to provide delivery instructions to a delivery agent at the residence, said delivery instructions including a communication identifying the container appliance. The premises management module 297 may be configured to provide delivery instructions to a delivery agent at the residence, and the delivery instructions may include a communication instructing the delivery agent to make use of said container appliance. The premises management module 297 may be configured to provide delivery instructions to a delivery agent at the residence, and the delivery instructions may include a communication instructing the delivery agent that recipient only accepts deliveries in secured condition. The premises management module 297 may be configured to provide delivery instructions to a delivery agent at the residence, and the delivery instructions may include a communication instructing the delivery agent that recipient is unavailable and accepts secured deliveries via the container appliance. The premises management module 297 may be configured to provide a delivery agent identification prompt requesting delivery agent identification input. The premises management module 297 configured to receive delivery agent identification input responsive to a delivery agent identification prompt. The premises management module 297 may be configured to provide delivery item registration prompt requesting delivery item registration input. The premises management module 297 configured to receive delivery item registration input responsive to a delivery item registration prompt. The premises management module 297 may be configured to provide delivery item registration input to the appliance management module for determining an authorized delivery event.

FIG. 3 is a flowchart illustrating a method 300 for secure deliveries, in an exemplary embodiment. Method 300 may include authorizing 305 a delivery event by the appliance management module of a container appliance. The container appliance may be identical to container appliance 200 shown in FIG. 2 and described in detail elsewhere herein. Method 30 may include detecting 310 the presence or arrival of a delivery agent in real-time at the residence for making a delivery to the container appliance. Method 30 may include qualifying 314 the delivery agent in real-time at the residence for making a delivery. Method 30 may include querying 318 to request identification information from the delivery agent in real-time for making a delivery at the residence. Method 300 may include communicating 322 with the delivery agent at the residence to identify the container appliance and by the appliance management module of a container appliance. Method 30 may include enabling 326 access to a storage compartment to receive a delivery item from the authorized delivery agent, by the appliance management module controlling the securing mechanism to enable such access. Method 30 may include denying 330 access to a storage compartment to prevent receiving a delivery item from the authorized delivery agent in the storage compartment, by the appliance management module controlling the securing mechanism to deny such access. Method 30 may include securing 334 a storage compartment to prevent removal of a stored delivery item, and to prevent receiving another delivery item from the authorized delivery agent, from the storage compartment during a storage period, by the appliance management module controlling the securing mechanism to secure the compartment from being accessed for removal of the stored delivery item. Method 30 may include determining 364 a storage period for a delivered item to be stored, in the storage compartment secured by the securing mechanism controlled by the appliance management module. Method 30 may include determining 368 an authorized removal event to enable removing a stored delivered item from the storage compartment in which the delivered item is securely stored, by the securing mechanism, in thermal controlled condition established by the thermal conditioning system, under control of the appliance management module.

Method 30 may include sending 372 a delivery notification for an authorized delivery event of a delivery item, to one or more computing devices selected by the final recipient for receiving such notifications. Such computing devices may include, for example, smartphones, wireless devices such as tablet computers, desktops, laptops, and email addresses or instant messaging accounts accessible from such devices. Method 30 may include issuing 376 a local notification of an authorized delivery event of a delivery item, to the final recipient or a related individual at the residence. Such local notification may include, for example, issuing an audible notification, visual notification such as an indicator light, or both.

Method 30 may include determining 338 a delivery time for an authorized delivery event, to enable access to a storage compartment at the delivery time for receiving a delivery item, and to enable thermal conditioning to establish a desired temperature in a thermal conditioned region of the storage compartment in relation to the delivery time.

Method 30 may include determining 342 dimensions of the thermal conditioned region of a storage compartment in relation to dimensions of a delivery item that is identified as requiring controlled temperature, by the appliance management module. In an embodiment, such dimensions may include height, length and width of a thermal conditioned region of a storage compartment in relation to a delivered item. In an embodiment, determining 342 dimensions of the thermal conditioned region of the storage compartment in relation to a delivery item that is identified as requiring controlled temperature may include, for example, selecting a storage compartment of adequate dimensions to receive the delivered item and also in relation to a then current temperature or estimated future temperature of the thermal conditioned region. So, for example, where the container appliance includes two or more storage compartments, and a first frozen storage compartment is already storing a frozen item such as a carton of ice cream at a designated temperature, then the appliance management module may determine that a later delivered second delivery item, such as a bag of ice, will be received in common in the same first frozen storage compartment holding the ice cream if the first frozen compartment volume is sufficient, or, if that volume is insufficient, may determine that the ice cream may be moved to a second frozen storage compartment and both items received and stored in common in the second frozen storage compartment large enough to hold both the ice cream and the bag of ice, and also may determine and control the different temperatures of both the first and second storage compartments accordingly. So, when both items are stored in the second frozen storage compartment, the chilling the frozen first compartment may be discontinued, and the temperature of the first compartment may be allowed to rise. Or, in an embodiment as described, the determining 342 by the appliance management module may include operating a thermal conditioning partition to enlarge the first storage compartment to a size adequate to receive and hold both of the delivery items, in the example both ice cream and a bag of ice, in the necessary frozen condition. It will be understood that, in embodiments, air space or air that otherwise might be present in a thermally conditioned region of a storage compartment may be controlled, displaced, replaced, reused, re-routed, moved, minimized or pressurized under control of the appliance management module to achieve economy in operation of the container appliance.

Method 30 may include identifying 346 the controlled temperature of a delivery item that is identified as requiring controlled temperature, to establish the controlled temperature of the delivery item during a secured storage period. Method 30 may include selecting 350 the thermal conditioned region of a storage compartment in relation to a delivery item that has been identified as requiring controlled temperature, to establish a designated temperature for the thermal conditioned region in relation to the controlled temperature identified for the delivery item.

Method 30 may include establishing 354 the designated temperature of thermal conditioned region of a storage compartment in relation to a delivery item that is identified as requiring controlled temperature, to establish the designated temperature of the thermal conditioned region and to establish the controlled temperature of the delivery item during the secured storage period. Method 30 may include controlling 358 the thermal conditioning system to establish a designated temperature of the thermal conditioned region of a storage compartment in relation to establishing a controlled temperature of a delivery item that is identified as requiring controlled temperature, to establish the designated temperature of the thermal conditioned region and to establish the controlled temperature of the delivery item during the secured storage period.

It will be understood that designated temperature for the thermal conditioned region may be different from controlled temperature of the delivery item, in order to establish a thermal gradient for changing temperature of the delivery item in relation to the controlled temperature or designated temperature. It will be understood that designated temperature may be varied, such as in a cycle, to establish a controlled temperature of the delivery item within a designated range, to avoid unnecessary energy consumption or to avoid unnecessary operation of components of the thermal conditioning system such as, for example, so as to reduce wear on wear components such as a compressor for refrigeration. It will be understood that designated temperature may be varied to establish a designated temperature of the thermal conditioned region within a designated range, to avoid unnecessary energy consumption or to avoid unnecessary operation of wear components. It will be understood that, in an embodiment, a thermal conditioning system may be operated in a short duration burst or flash to provide rapid heat transfer for cooling or heating a delivery item, by establishing a large thermal gradient in relation to a current temperature, estimated or actual delivery temperature, or designated temperature of a delivery item. It will be understood that, in an embodiment, a thermal conditioning system may be operated for a long duration to provide slow heat transfer for cooling or heating a delivery item, by establishing a small thermal gradient in relation to a current temperature, estimated or actual delivery temperature, or designated temperature of a delivery item. It will be further understood that a large thermal gradient may be established between a delivered item and a thermal conditioning system, along a quick-acting thermal transfer path, such as, for example, connecting an efficient conductor such as metal, between the delivered item and thermal conditioning system at different temperatures.

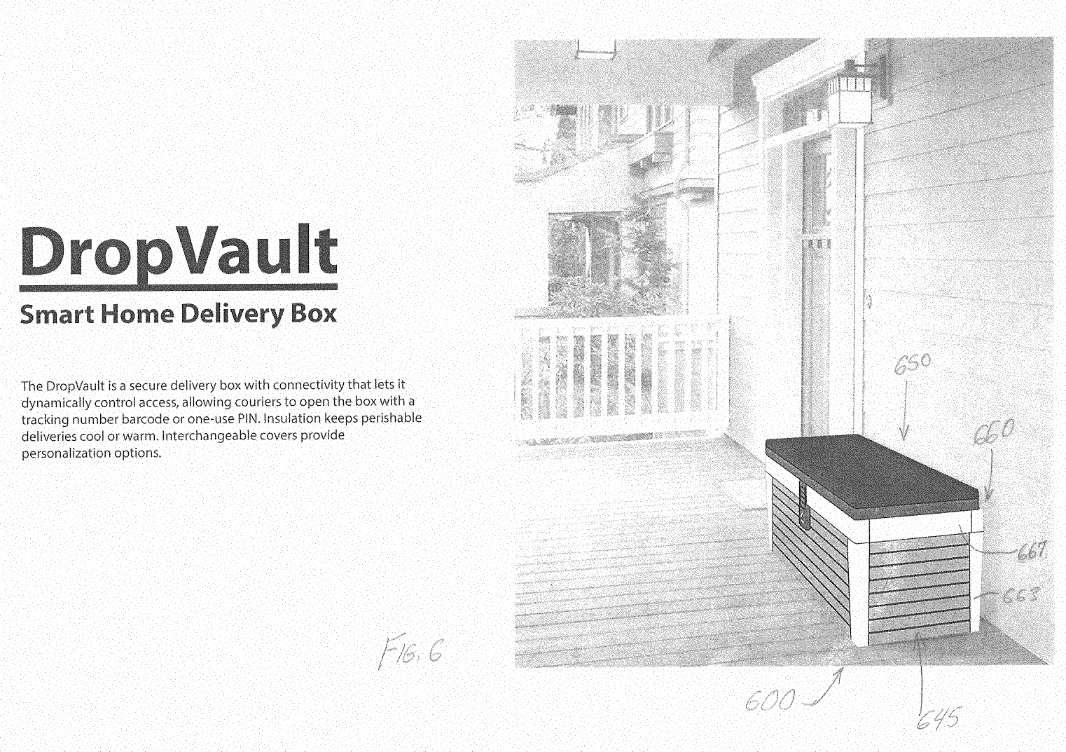

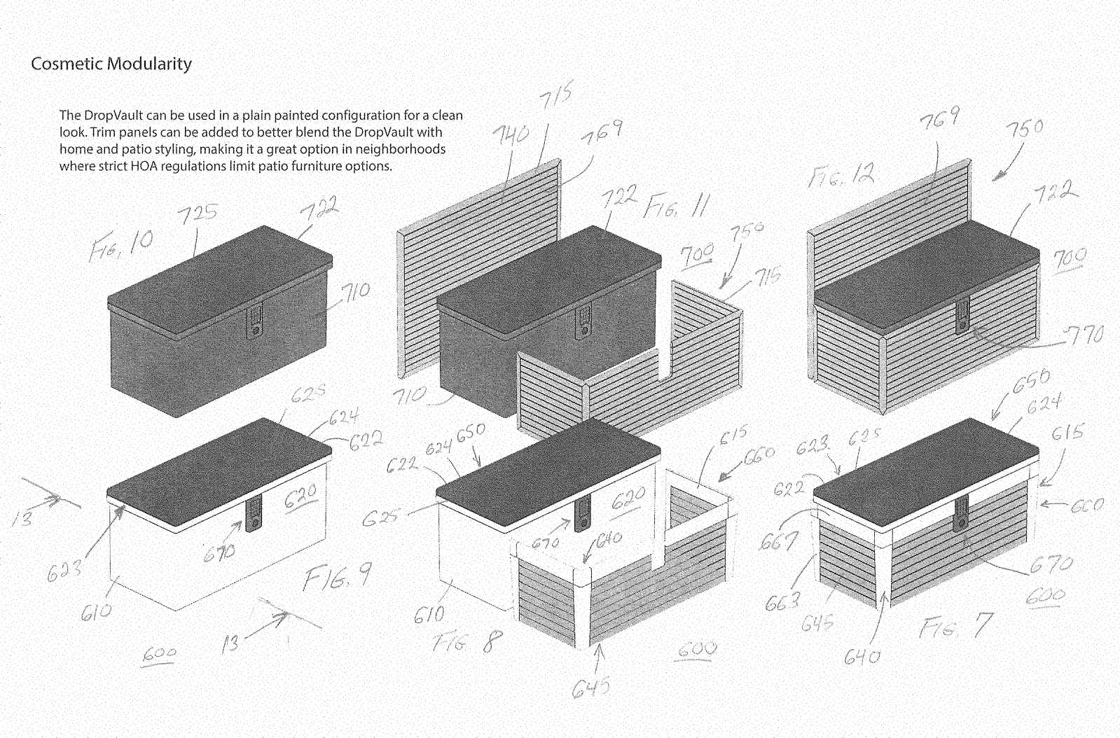

FIG. 6 is an end perspective view of a container system 600 in an exemplary embodiment, installed for use at a residence. FIG. 7 is a front perspective view of the container system 600 shown generally in FIG. 6. FIG. 8 is an exploded perspective view similar to FIG. 7, showing the container system 600 including a container appliance 610 and a set of ornamental panels 615. FIG. 9 is a perspective isolation view similar to FIG. 8, showing the container appliance 610 of the container appliance of system 600 and omitting the set of ornamental panels 615 (shown in FIG. 8). Container appliance 610 may be identical to previously described container appliance 210, except as otherwise described herein or illustrated in the drawings.

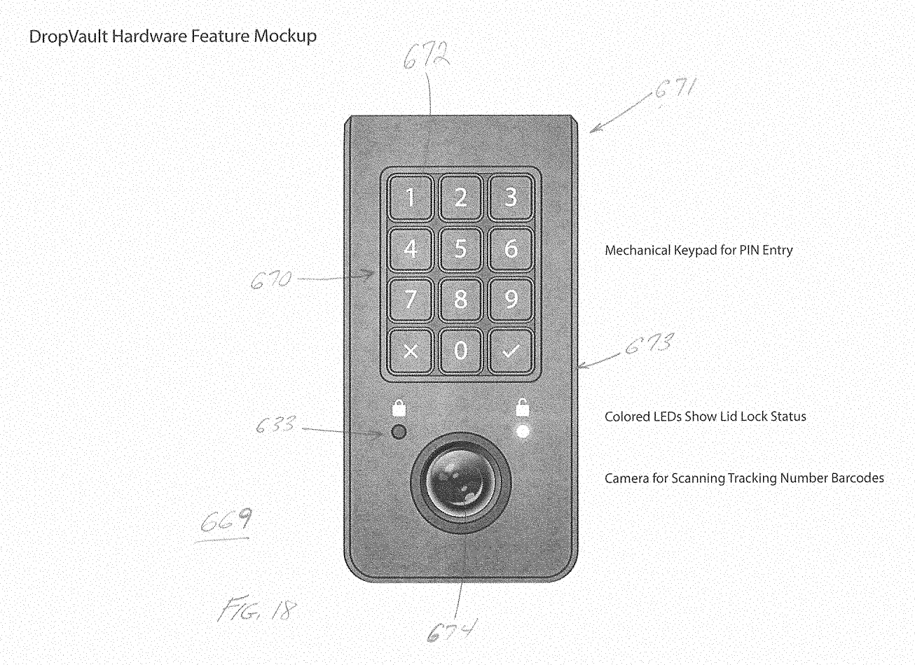

As shown in FIG. 8, container appliance 610 includes a set of insulated sidewalls 620. As shown in FIG. 13, cooperation of the set of insulated sidewalls 620 and an insulated lid 622 defines a storage compartment 630 in an open interior space. Insulated lid 622 which is pivotable on hinges between a raised, open position and a lowered, closed position. In the closed position (shown in FIGS. 7, 8, 9 and 13, the insulated lid 622 cooperates with the set of insulated sidewalls 620 to enclose storage compartment 630. The insulated lid 622 is moveable to the open position for a user, such as the owner or a delivery person, to access the open storage compartment 630 for placing or removing goods therein. The insulated lid 622 may include a secondary function element 623 on the exterior surface to provide ornamentation and performing a secondary function. In the particular embodiment shown, the secondary function element 623 is a bench seat 624.

FIG. 13 is a schematic simplified cross-sectional view of the container appliance 610 of container system 600, taken generally along 13-13 in FIG. 9. Temperature of the storage compartment 630 and/or goods 631 or items stored therein may be controlled. As shown in FIG. 13, temperature control of storage compartment 630 and/or goods or items stored therein may be provided by a packaged refrigerant 635. Packaged refrigerant 635, for example, may be a reusable or single-use freezer pack. A suitable freezer pack or packaged refrigerant 635, for example, may be a Blue Ice Block packaged refrigerant available from Newell Rubbermaid (Atlanta, Ga.) or a packaged Ice Brix refrigerant available from Polar Tech Industries (Genoa, Ill.). As shown in FIG. 13, container appliance 610 may have an integral or unitary major structure 615, which includes the set of insulated sidewalls 620 being formed in, or defining, an integral or unitary molded plastic and insulating foam cooler structure. Such a major structure 615 consisting of an integral molded plastic 616 and insulating foam 617 cooler structure, may be manufactured in the same or similar manner of a molded plastic and foam recreational ice-containing cooler of the type available from Igloo Products Corp. (Katy, Tex.) or Yeti Inc. (Austin, Tex.). In an embodiment, a container appliance (not shown) may have an integrated or unitary molded or stamped construction of primarily metal with internal insulating foam, manufactured in the same or similar manner of a metal and foam recreational or commercial ice-containing cooler of the type available from Igloo Products Corp. (Katy, Tex.) or The Coleman Company Inc. (Wichita, Kans.). The major structure 615 of container appliance 610 thus may differ in this aspect from the major structure of previously described container appliance 210.

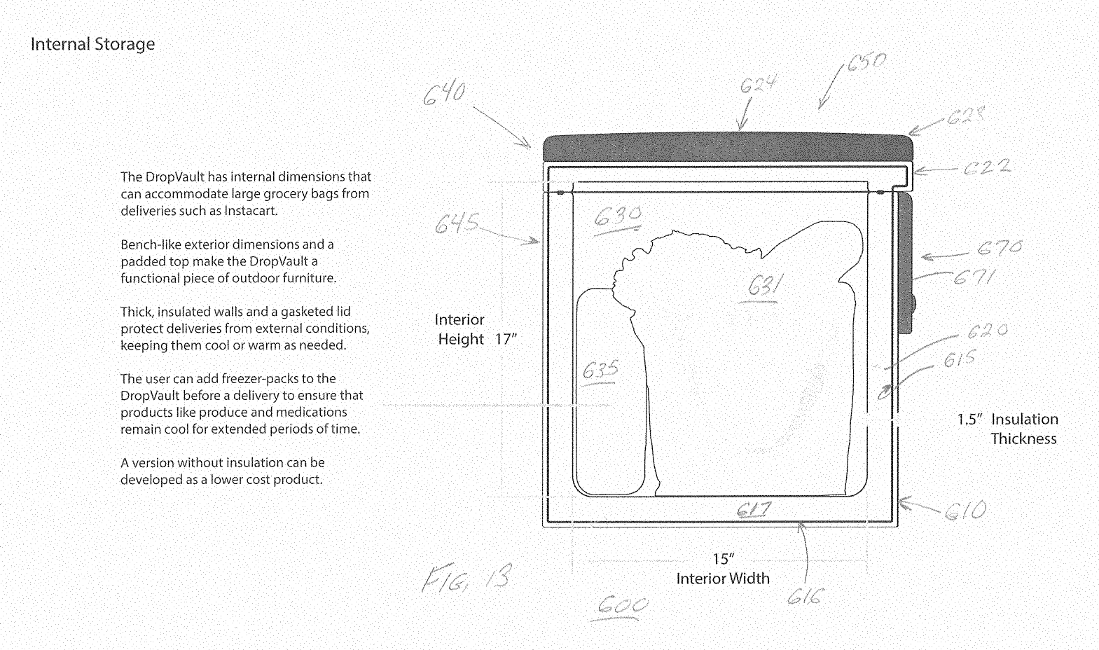

Referring to FIGS. 7, 8 and 9, visible portions of the exterior of container system 600 may include a set of ornamental appearance elements 640. The set of ornamental appearance elements 640 may include changeable elements such as, for example, a set of changeable ornamental exterior panels 645 secured to the major structure 615 of appliance container 610, such as by suitable threaded fastener combinations, such as bolt and nut combinations (not shown). The changeable ornamental exterior panels 645 may be configured to provide aesthetic consistency with the building environment and to improve security in concealing the existence of the storage compartment 630 from casual visual perception by exhibiting a secondary function on the exterior of container system 600. In the particular embodiment shown, the secondary function exhibited by the exterior of container system 600 is a bench seating system 650. The bench seating system 650 may include bench 623 located on the external top surface of insulated lid 622. The bench seating system 650 may include a bench frame 660 defined by the set of ornamental exterior panels 645. The bench frame 660 may include a set of bench legs 663 and seat frame 667. In the embodiment, container system 700 shown in FIGS. 10, 11 and 12 may include bench seating system 750 including a seat back 769 extending above the bench 723.

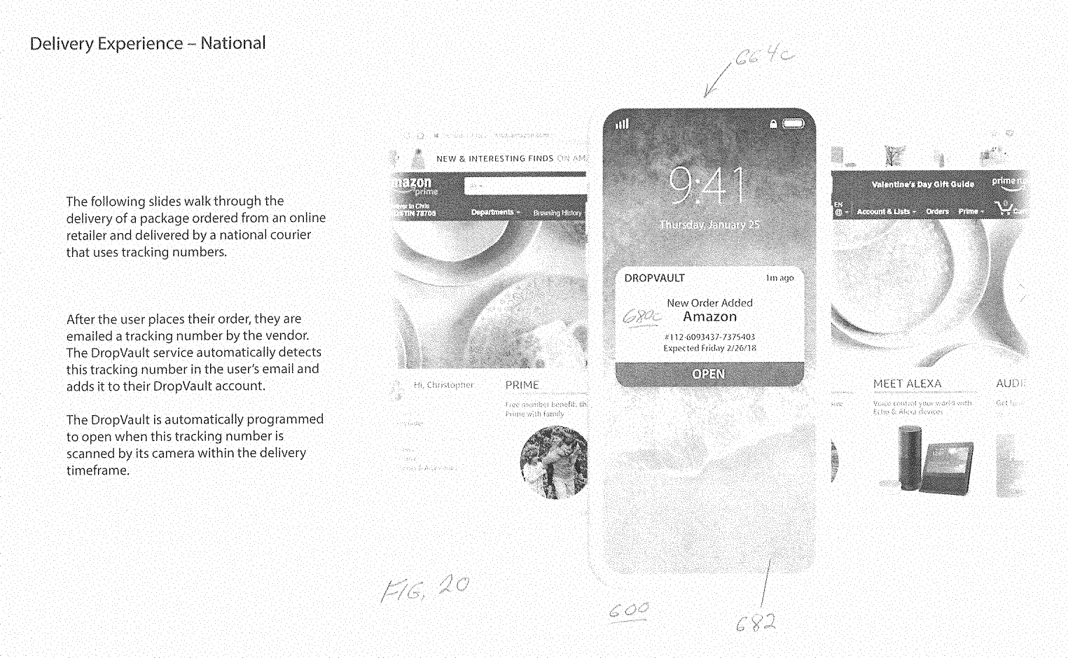

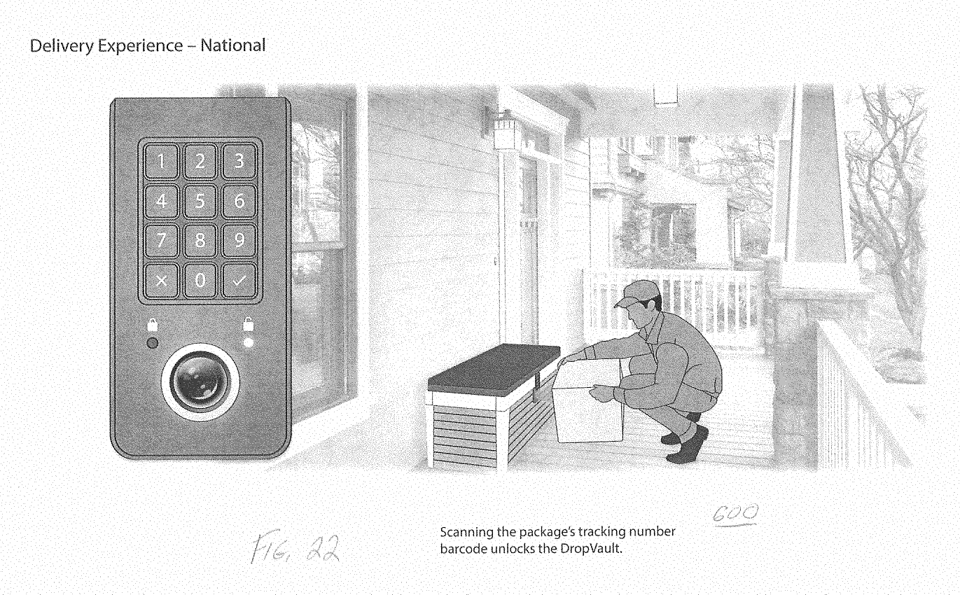

Referring to FIG. 13, container appliance 610 may include a door or lid securing mechanism 670. As shown in FIG. 18, the securing mechanism 670 may include, for example, a keypad 672 in communication with a locking mechanism (not shown) configured for unlocking the insulated lid 622 (shown in FIG. 13) from a closed and locked condition. The keypad 672 may be part of a multi-function control unit 671. The multi-function control unit 671 may be part of an appliance management module 669 configured to manage the appliance system 600. The system management module 669 may have a processor, memory, application software executable by the processor, power supply, a network interface, a communications network connection such as a wireless transceiver, (not shown) and may be located or contained in a housing 673. The system management module 669 may include a processor, memory and application software executable by a server remote from the container appliance 610. The multi-function control module 671 may perform steps for management, securing and communications with wireless communication devices associated with each of the users acting in different roles such as delivery end recipient who typically owns or possesses the container appliance at a residential location, and delivery persons who make deliveries and place goods into the container appliance 610. Keypad 672 may include a set of input keys corresponding to numerals 0-9, for users to enter unlock codes, such as a PIN, to unlock the locking mechanism (not shown) that secures the insulated lid 622 in the closed and locked condition. The unlock code or PIN may be provided to an authorized delivery person by a communication management module that provides the information at a user interface (see FIG. 15) on a wireless mobile device associated with the delivery person. Securing mechanism 670 may include, for example, a camera 674 located with the keypad 672 to record a time-stamped visual image record such as photos or video of users who use the keypad or approach the container appliance 610. In an embodiment, the camera 674 also may be configured to function as code scanner and receiver for an authorization code, such as an identification card of a delivery person. In an embodiment, the multi-function control module 671 may include a barcode scanner (not shown) to perform scanning, processing and recording of barcodes associated with delivered goods, for the system to identify goods placed into the container appliance 610 by a delivery person. The securing mechanism 670 may be configured, controlled or managed by the appliance management module 669 to re-lock when the insulated lid 622 is moved to the closed position after goods are placed into the storage compartment 630. It will be understood that the appliance management module 669 may generate a delivery notification message for the end recipient and via the communications module may send the delivery notification message to a mobile wireless device 664b associated with the end recipient, such that a user interface 668b is generated on the touchscreen of the mobile wireless device 664b, informing the end recipient that a particular authorized delivery has been received at a delivery time when the lid is unlocked, re-locked or another related event occurs and is tracked for reporting to users authorized to receive a report of the event. It will be understood that in an embodiment, the appliance management module 669 may determine authorization for a delivery person associated with an authorized delivery, generate an unlock code or PIN notification message for use by the delivery person, and via the communications module may send a delivery notification message to a mobile wireless device 664a associated with the delivery person, such that a user interface 667 (shown in FIG. 15) is generated on the touchscreen of the mobile wireless device 664a, informing the delivery person that the particular unlock code or PIN is authorized to be entered into the appliance management module 669 via the keypad 672 for causing the securing mechanism to unlock the lid 622 and thus provide access to the storage compartment 630 for the authorized delivery person to place the authorized delivery of goods into the storage compartment 630 before the appliance management module 669 thereafter controls the securing mechanism to re-lock the lid 620 in the closed position and send a notification message to the wireless device 664b associated with the end recipient who owns and/or controls the container appliance 610. It will be understood that the camera 674 may be operably connected to a processor and memory for image capture, processing and recording of visual images taken by the camera 674. Container appliance 610 may include a set of indicator lights 633 configured to provide visual indication of locked or unlocked status when illuminated or not illuminated. The securing mechanism 670 interacts with the insulated lid 622 to enable opening of the insulated lid 623 when selectively controlled by the user entering an authorized unlock code via the keypad 672 to enable user access to the storage compartment 630 where access is authorized, such as during authorized delivery events and authorized removal events. It will be understood that container appliance 610 may include an appliance management module 669 similar to appliance management module 270 of the container appliance 210 previously described and illustrated. The appliance management module 669 may be configured and operable to control operations of the appliance container 610. In the illustrated embodiment, appliance management module 669 may be configured to control operation of the securing mechanism as described hereinabove. In the illustrated embodiment, the appliance management module 669 may include a communications management module (not shown) similar to the communications management module 291 of appliance container 210, which was previously described hereinabove and shown in FIG. 2). The communications management module may be configured to control operation of a communication system including a local communication system for local communications at the residence where the appliance container 610 is located, with delivery persons, the end recipient and trusted individuals at the residence. The communications management module may include a remote communication system for remote communications with users including delivery persons, the end recipient, and trusted individuals when these users are away from the residence. The communications management module may be configured to control operation of a network communication system (not shown) operable to provide communications with remote devices over the communications network. The appliance management module 669 may include a premises management module configured to control, and to receive information from, a local premises monitoring system operable for sensing or detecting the presence of delivery persons at the residence. The appliance management module may include camera 674 operable for sensing or detecting the presence of delivery persons. The appliance management module 669 may include a speech synthesizer (not shown) and audio speaker (not shown) operable for issuing audible signals, instructions or questions to delivery persons and the end user when near the container appliance 610, and a set of microphones (not shown) for detecting and receiving voice communications from delivery persons and the end user. The appliance management module 669 may be configured to control the local communication system for issuing communications requesting, and for receiving, qualifying identification information from delivery persons at the residence. Communications may be received from any suitable input device or sensor including, for example, microphone, scanner, touchscreen, camera, or other suitable input interfaces or sensors. Communications may be issued from any suitable output device including, for example, speakers, visual displays, alarms and notification lights such as LEDs. The local communication system may issue local notifications to the end recipient or trusted individuals at the residence, or to delivery persons at the residence.

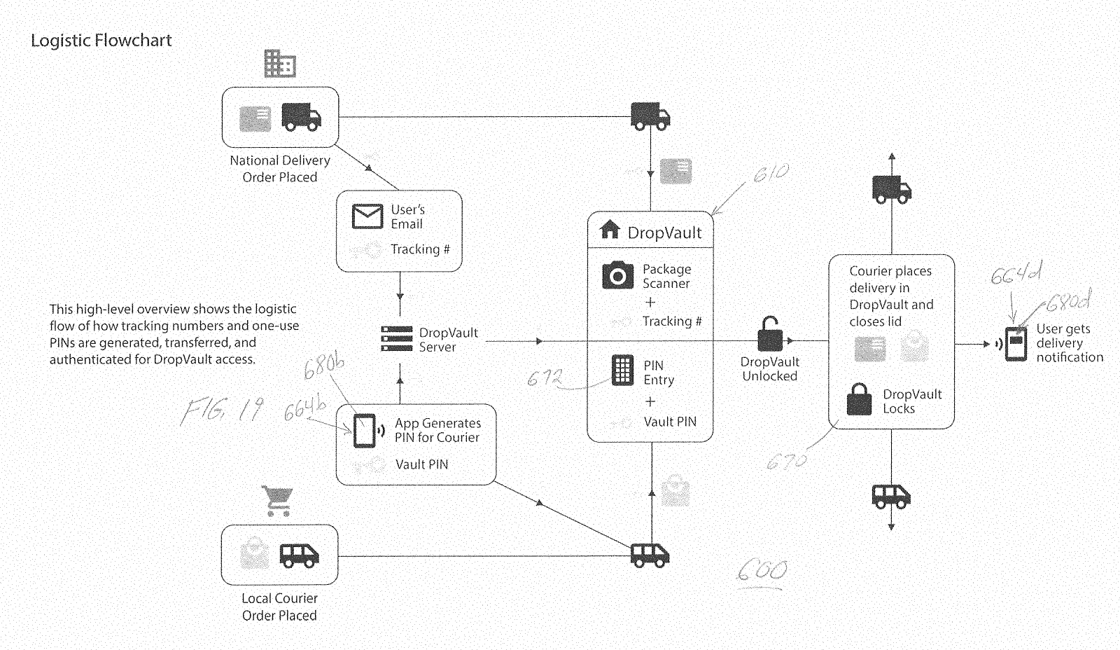

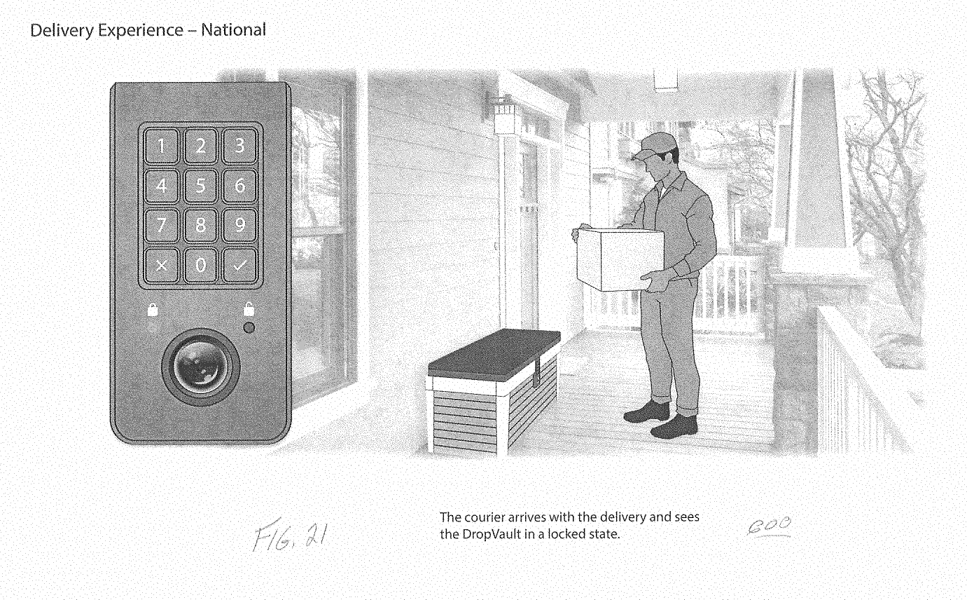

In container appliance 610, the appliance management module 669 may be configured to determine and control operating periods and position or status (locked or unlocked) for the securing mechanism 670 to lock the insulated lid 622 in the closed position or unlock the insulated lid 622 to permit moving the same to the open position. FIG. 14 is a simplified first screenshot view illustrating an exemplary first user interface 680a for the container system 600 shown generally in FIG. 6 depicting an order delivery schedule message. FIG. 15 is a simplified second screenshot view similar to FIG. 14, illustrating an exemplary second user interface 680b for the container system 600, depicting an authorization message including an authorized unlock code or PIN displayed on the touchscreen interface of a mobile wireless device 664b, for use by the recipient delivery person to unlock the lid 622 and thus gain access to the storage compartment 630. FIG. 16 is a simplified third screenshot view similar to FIG. 14, illustrating an exemplary third user interface 680c for the container system 600 depicting an order delivery message. FIG. 17 is a simplified fourth screenshot view similar to FIG. 16, illustrating an exemplary fourth user interface 680d for the container system 600 depicting a container opened message. Referring to FIGS. 14, 15, 16 and 17, the communications management module 669 may be configured to provide any one of a set of user interfaces 680a, 680b, 680c, 680d on a touchscreen display 682 of mobile wireless devices 664a, 664b, 664c, 664d associated with users. Each one of the set of user interfaces 680a, 680b, 680c, 680d may provide a communication to the user. The user interface 680a shown in FIG. 14, for example, provides information regarding expected deliveries to the container appliance 610 for an end recipient. The user interface 680b shown in FIG. 15, for example, provides information regarding an authorized unlocking code for a delivery person to enter on the keypad 662 (FIG. 18) to unlock the locking mechanism and release the insulated lid 622 (FIG. 13) for the lid 622 to be opened to receive an authorized delivery in the storage compartment 630 of the container appliance 610. The user interface 680c shown in FIG. 16, for example, provides information to the end recipient regarding new orders for which a delivery of goods into the container appliance 610 is to be expected. The user interface 680d shown in FIG. 17, for example, provides information to the end recipient regarding an opening event or closing event in operation of the container appliance 610 for actual delivery and receiving of an authorized delivery of goods into the container appliance 610. The information may include, for example, a delivery reference number and time when the lid 622 of the container appliance 610 was opened by entry of an authorized code on the keypad 672 (shown in FIG. 18).

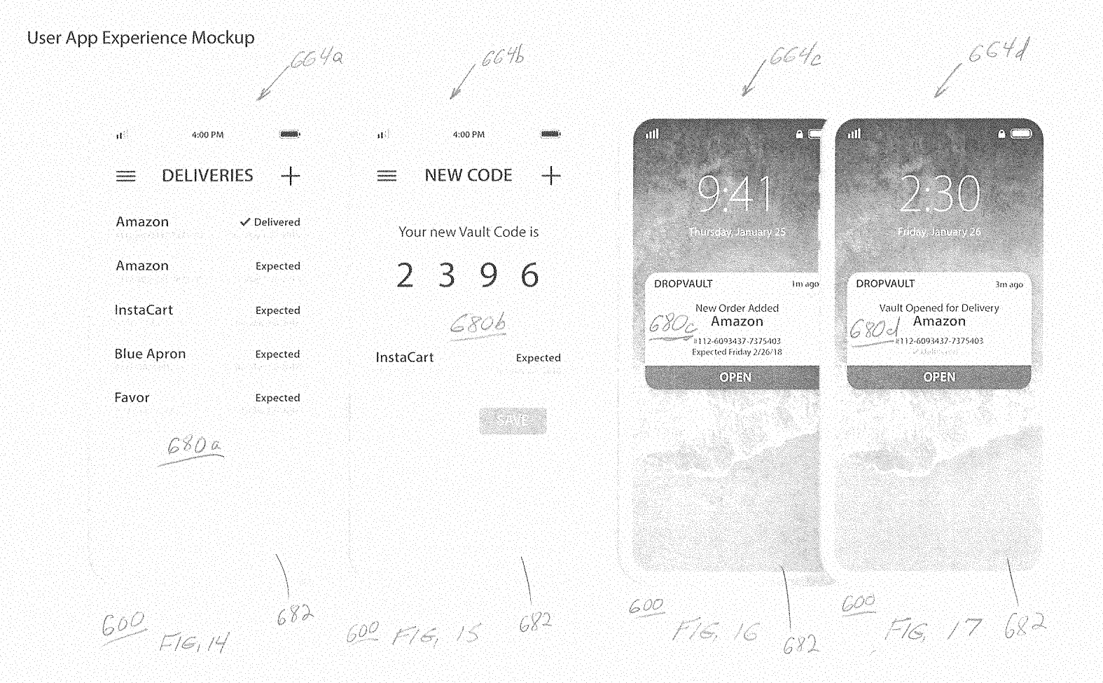

FIG. 10 is a perspective isolation view similar to FIG. 9, showing the container appliance 705 of a container system 700 in an exemplary embodiment. FIG. 11 is an exploded perspective view similar to FIG. 8, illustrating a container appliance 710 and set of ornamental panels 715 of container system 700, the container appliance 710 of same being shown generally in FIG. 10. FIG. 12 is a front perspective view similar to FIG. 7, illustrating container system 700 as shown generally in FIG. 11. Container system 700 is identical to previously described container system 600, except as otherwise described or illustrated. As best shown in FIG. 11, container system 700 includes container appliance 710 and a set of ornamental panels 715. As shown in FIGS. 10-11, in container system 700, the container appliance 710 has a dark exterior, whereas the container appliance 610 in container system 600 has a white exterior. As best shown in FIGS. 11-12, in container system 700 the set of ornamental panels 715 includes a backrest extension 715 extending above the lid 722 defining a bench seat 725, whereas in container system 600 each of the ornamental panels 615 terminates at the height of lid 620 defining bench seat 625.

FIG. 18 is a simplified partial front view of a multi-purpose input unit 671 of the appliance management module 669 of the container system 600 shown generally in FIG. 9, with a set of indicator lights 633 illuminated to show locked and unlocked status. The multi-purpose input unit 671 includes keypad 672, camera 674 and indicator lights 633 mounted in a housing 673. The housing 673 may contain processor, memory, and power and may be configured to perform functions of the appliance management module 669.

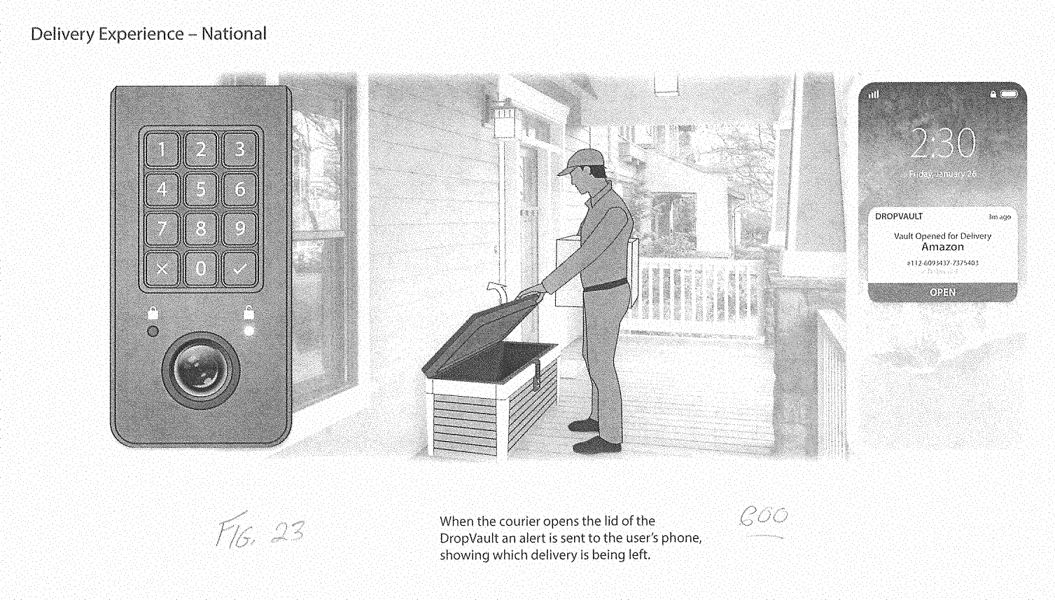

FIG. 19 is a simplified schematic logistic flowchart illustrating aspects of the container system 600 shown generally in FIG. 9. As shown in FIG. 19, container system 600 may include the container appliance 610 having a system management module 669 configured to perform steps for management, securing and communications of container system 100. Container appliance 610 may be configured for communication with wireless communication devices associated with users acting in different roles, such as the delivery end recipient who typically owns or possesses the container appliance at a residential location, and delivery persons who make deliveries and place goods into the container appliance 610.

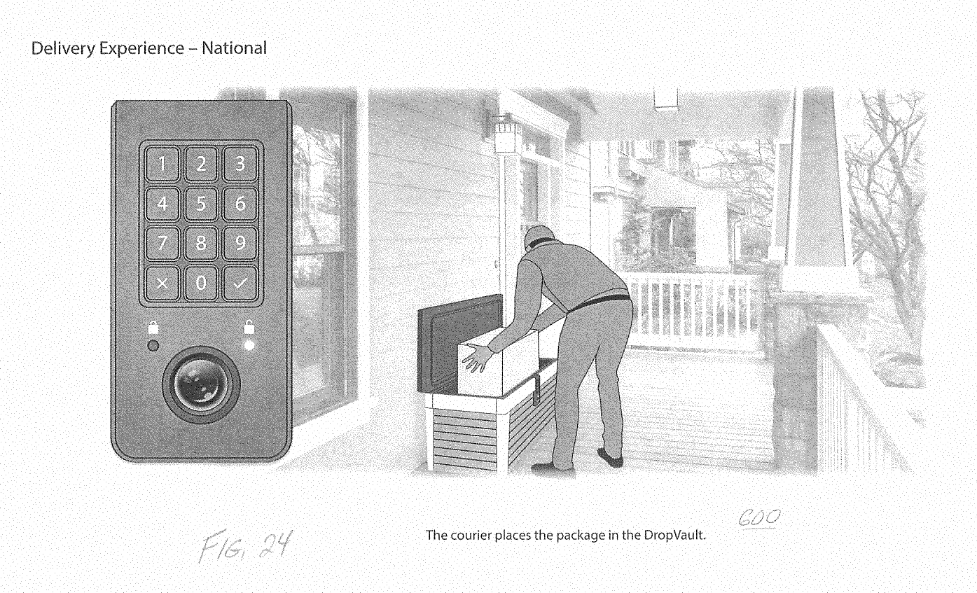

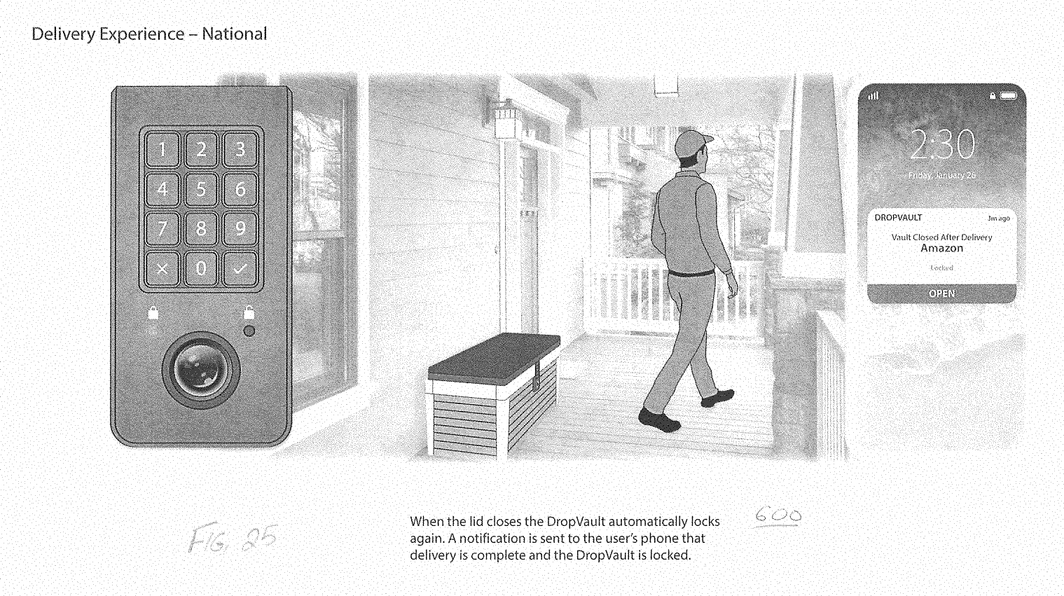

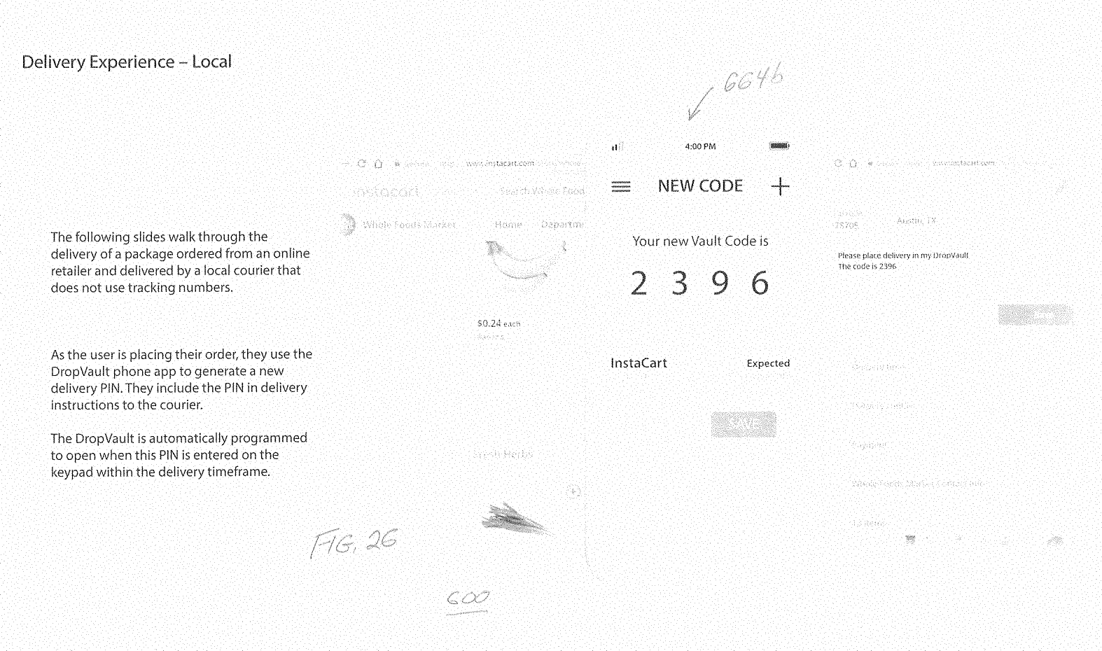

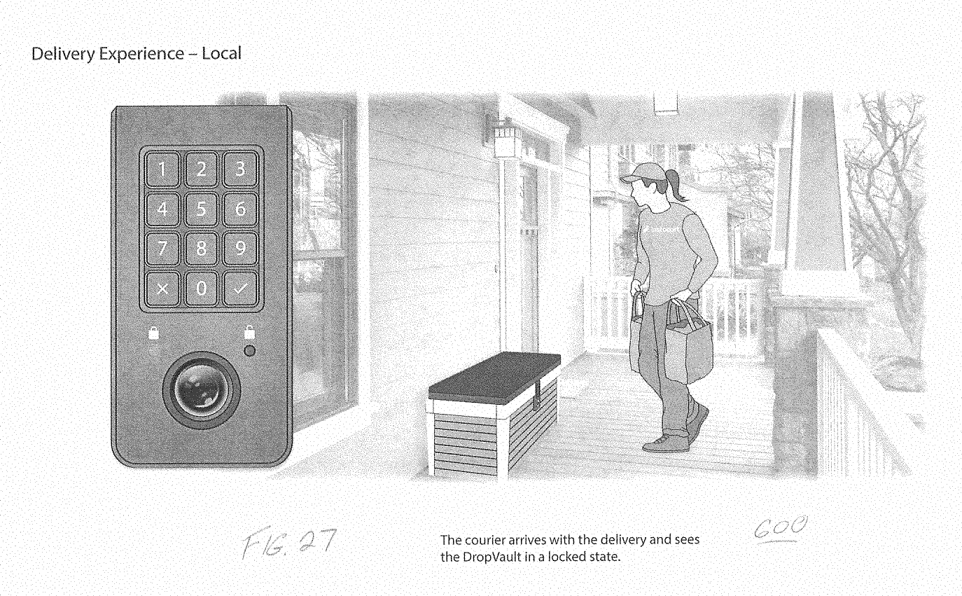

FIGS. 20-25 illustrate an exemplary series of operations of container system 600 for a delivery by a national delivery service, from generation of a planned order delivery message through automatic re-locking of the container system after the national delivery service order is physically received in the container system.

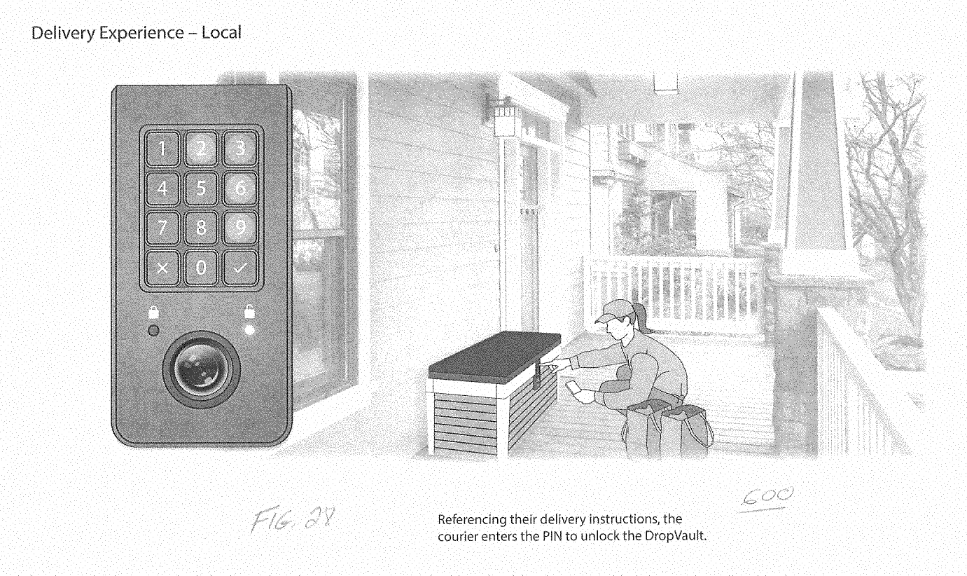

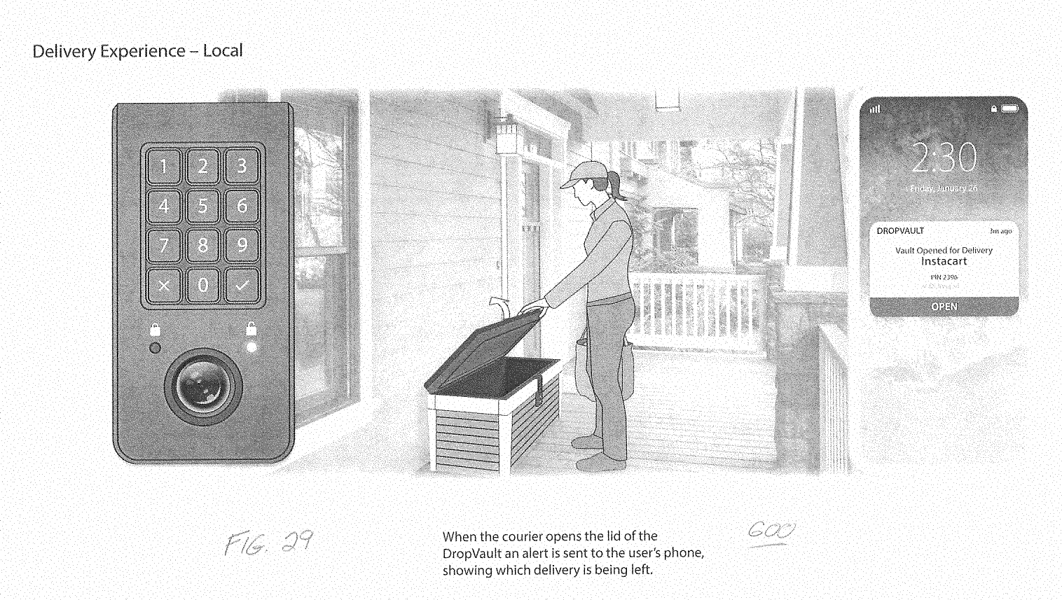

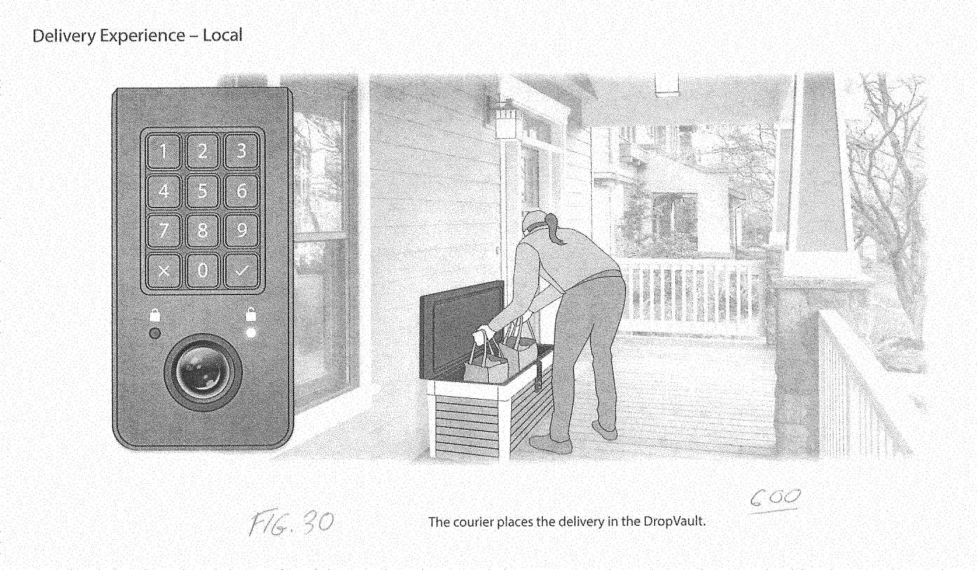

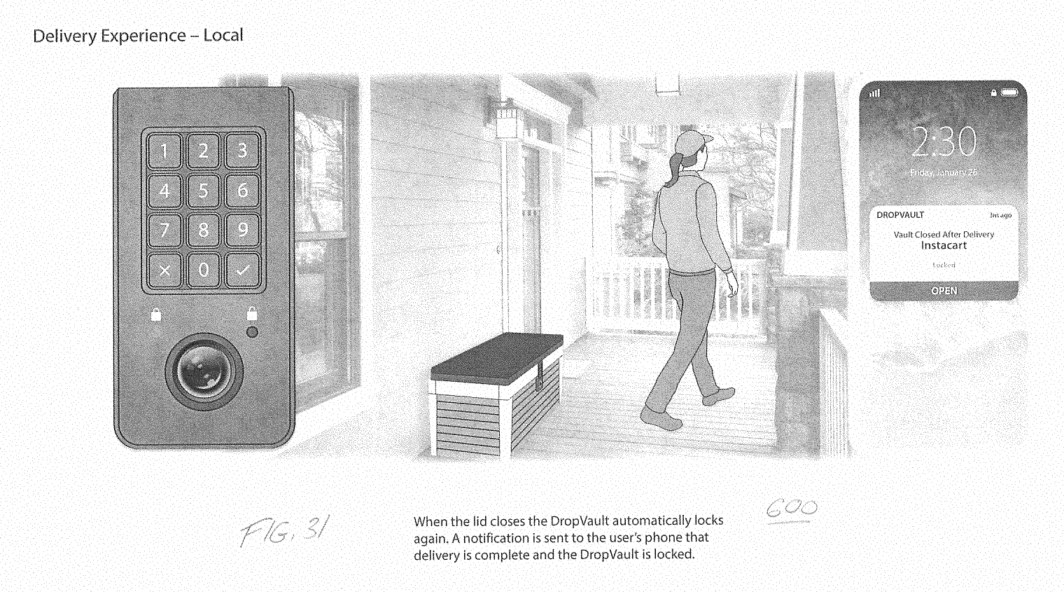

FIGS. 26-31 illustrate an exemplary series of operations of container system 600 for a delivery by a local business, from generation of a delivery code authorization message through automatic re-locking of the container system after the local business delivery is physically received in the container system.

Apparatus, methods and systems according to embodiments of the disclosure are described. Although specific embodiments are illustrated and described herein, it will be appreciated by those of ordinary skill in the art that any arrangement which is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art will appreciate that implementations can be made for other fields of art, systems, apparatus or methods that provide the required functions.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials.

Terminology used in the present disclosure is intended to include all environments and alternate technologies that provide the same functionality described herein.

What is claimed is:

1. A container appliance for secure receiving and storing of delivered items at a residence of a final recipient, said container appliance comprising:
a storage compartment located in an interior portion of said container appliance, said storage compartment accessible from outside said container appliance by a delivery agent during an authorized delivery event, for said storage compartment to receive a delivered item from the delivery agent;
a securing mechanism selectively controllable to deny access for removal of the delivered item from said storage compartment during a secured storage period, said securing mechanism selectively controllable to permit access for removal of the delivered item from said storage compartment during an authorized removal event;
a thermal conditioning system operable for establishing a temperature of at least one of said storage compartment and said delivered item stored in said storage compartment;
an appliance management module comprising a processor and memory combination operable to execute instructions, said appliance management module:
configured to control said thermal conditioning system to establish a designated temperature condition for the delivered item during the secured storage period;
configured to selectively control said securing mechanism to:
permit access by an authorized delivery agent during each authorized delivery event,
permit access during each authorized removal event, and
deny access during each secured storage period;
configured to cause the sending of a delivery notification to a computing device designated for communications to the final recipient;
configured to control the displaying of a local notification signal detectable at said container appliance.

2. A container appliance according to claim 1, further comprising:
said appliance management module controlling said thermal conditioning system to establish the designated temperature by reference to a delivery time for the delivered item.

3. A container appliance according to claim 2, further comprising:
said delivery time being determined by reference to a planned delivery schedule for the delivery agent.

4. A container appliance according to claim 2, further comprising:
said delivery time being determined by a near real-time communication with the delivery agent to obtain information while the delivery route is in progress.

5. A container appliance according to claim 1, further comprising:
said storage compartment comprising a thermally conditioned region receiving the delivered item, said thermally conditioned region selected to minimize power consumption relative to a thermally conditionable region larger than said selected region.

6. A container appliance according to claim 1, further comprising:
said appliance management module configured to control said thermal conditioning system to establish the designated temperature in relation to delivery time information for the authorized delivery event.

7. A container appliance according to claim 1, further comprising:
said appliance management module configured to control said thermal conditioning system to establish the designated temperature in relation to temperature information for the delivered item during the secured storage period.

8. A container appliance according to claim 1, further comprising:
said appliance management module configured to control said thermal conditioning system to establish the designated temperature in relation to near-real time temperature information for the delivered item during the secured storage period.

9. A container appliance according to claim 1, further comprising:
said appliance management module configured to control said thermal conditioning system to establish the designated temperature in relation to near-real time temperature information for the delivered item during at least one of: the authorized delivery event and a delivery route period, wherein the delivery route period precedes the authorized delivery event.

10. A container appliance according to claim 1, further comprising:
said storage compartment comprising a thermally conditioned region for receiving the delivered item, said thermally conditioned region having a selectable size property.

11. A container appliance according to claim 1, further comprising:
said storage compartment comprising a thermally conditioned region for receiving the delivered item, said thermally conditioned region characterized having a selectable size property by being sub-dividable to partition the thermally conditioned region into a minor thermally conditioned region and an unconditioned region for establishing temperature only in said minor thermally conditioned region for a particular secured storage period.

12. A container appliance according to claim 1, further comprising:
said storage compartment comprising a thermally conditioned region for receiving the delivered item, said thermally conditioned region having a selectable size property comprising a plurality of partitioned compartments.

13. A container appliance according to claim 1, further comprising:
said storage compartment comprising a thermally conditioned region for receiving the delivered item, said thermally conditioned region having a selectable size property comprising a plurality of partitioned compartments each having changeable partitions.

14. A container appliance according to claim 1, further comprising:
said storage compartment comprising a thermally conditioned region for receiving the delivered item, said thermally conditioned region comprising a plurality of partitioned compartments each comprising a different designated thermal zone.

15. A container appliance according to claim 1, further comprising:
said thermal conditioning system selected from the following: refrigeration system, heating system, refrigeration and heating system, hybrid system.

16. A container appliance according to claim 1, further comprising:
a condensate control system configured to direct condensate produced from operation of said thermal conditioning system to a condensate collector.

17. A container appliance according to claim 1, further comprising:
a condensate control system configured to operate in a condensate elimination mode, wherein in said condensate elimination mode said condensate control system actively establishes conditions to prevent appearance of condensate on visible ornamental portions of said container appliance.

18. A container appliance according to claim 1, further comprising:
said thermal conditioning system controllable for intermittent operation.

19. A container appliance according to claim 1, further comprising:
said appliance management module configured to authorize a series of authorized delivery events, said appliance management module configured to configure said securing mechanism to prevent unauthorized access for removing a delivered item from said storage compartment by an unauthorized entity.

20. A container appliance according to claim 1, further comprising:
said appliance management module configured to authorize a series of authorized delivery events in relation to a recipient authorization prompt.
